(19) United States
(12) Patent Application Publication
(10) Pub. No.: US 2025/0107545 A1
(43) Pub. Date: Apr. 3, 2025

(54) FUNCTIONALIZED, NON-DAIRY BASE MIXTURE AND METHOD FOR PRODUCING NON-DAIRY ANALOGS

(71) Applicant: Eclipse Foods Co., Oakland, CA (US)

(72) Inventors: Thomas Elliot Bowman, Oakland, CA (US); Benjamin Thomas Roche, Oakland, CA (US)

(21) Appl. No.: 18/981,148

(22) Filed: Dec. 13, 2024

Related U.S. Application Data
(63) Continuation-in-part of application No. 18/126,323, filed on Mar. 24, 2023.
Application No. 18/126,323 is a continuation-in-part of application No. 17/705,127, filed on Mar. 25, 2022.
Application No. 17/705,127 is a continuation-in-part of application No. 17/086,252, filed on Oct. 30, 2020, now abandoned.
Application No. 17/086,252 is a continuation of application No. 16/820,502, filed on Mar. 16, 2020.
(60) Provisional application No. 63/609,760, filed on Dec. 13, 2023.
(60) Provisional application No. 62/874,885, filed on Jul. 16, 2019.
(60) Provisional application No. 62/819,431, filed on Mar. 15, 2019.

(51) Int. Cl. A23C 11/06; A23C 20/02; A23G 9/32; A23G 9/34; A23G 9/38; A23G 9/42

(52) U.S. Cl. CPC A23C 11/06; A23C 20/02; A23G 9/327; A23G 9/34; A23G 9/38; A23G 9/42

(57) ABSTRACT

One variation of a non-dairy milk product includes: a first portion of a starch; a second portion of plant-extracted proteins; a first amount of a first enzyme configured to catalyze hydrolysis of a first proportion of the first portion of the starch into sugar units; a second amount of a second enzyme configured to catalyze hydrolysis of a second proportion of the second portion of plant-extracted proteins into amino acids; and a third amount of a third enzyme configured to catalyze synthesis of protein bonds between plant-extracted proteins in a third proportion of the second portion of the plant-extracted proteins to form a protein matrix.

### CROSS-REFERENCE TO RELATED APPLICATIONS

This Application is a continuation—in-part of U.S. patent application Ser. No. 18/126,323, filed on 24 Mar. 2023, which is a continuation—in-part of U.S. patent application Ser. No. 17/705,127, filed on 25 Mar. 2022, which is a continuation—in-part of U.S. patent application Ser. No. 17/086,252, filed on 30 Oct. 2020, which is a continuation of U.S. patent application Ser. No. 16/820,502, filed on 16 Mar. 2020, which claims the benefit of U.S. Provisional Application No. 62/874,885, filed on 16 Jul. 2019, and U.S. Provisional Application No. 62/819,431, filed on 15 Mar. 2019, each of which is incorporated in its entirety by this reference.

This Application also claims the benefit of U.S. Provisional Application No. 63/609,760, filed on 13 Dec. 2023, which is incorporated in its entirety by this reference.

### TECHNICAL FIELD

This invention relates generally to the field of food science and, more specifically, to a new and useful non-dairy base mixture and method for producing non-dairy analogs in the field of food processing.

### BRIEF DESCRIPTION OF THE FIGURES

FIG. 1 is a flowchart representation of a method;

FIGS. 2A and 2B are flowchart representations of the method;

FIGS. 3A and 3B are schematic representations of a base mixture;

FIG. 4 is a flowchart representation of one variation of the method;

FIG. 5 is a flowchart representation of one variation of the method;

FIGS. 6A, 6B, and 6C are schematic representations of the base mixture; and

FIG. 7 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Base Mixture

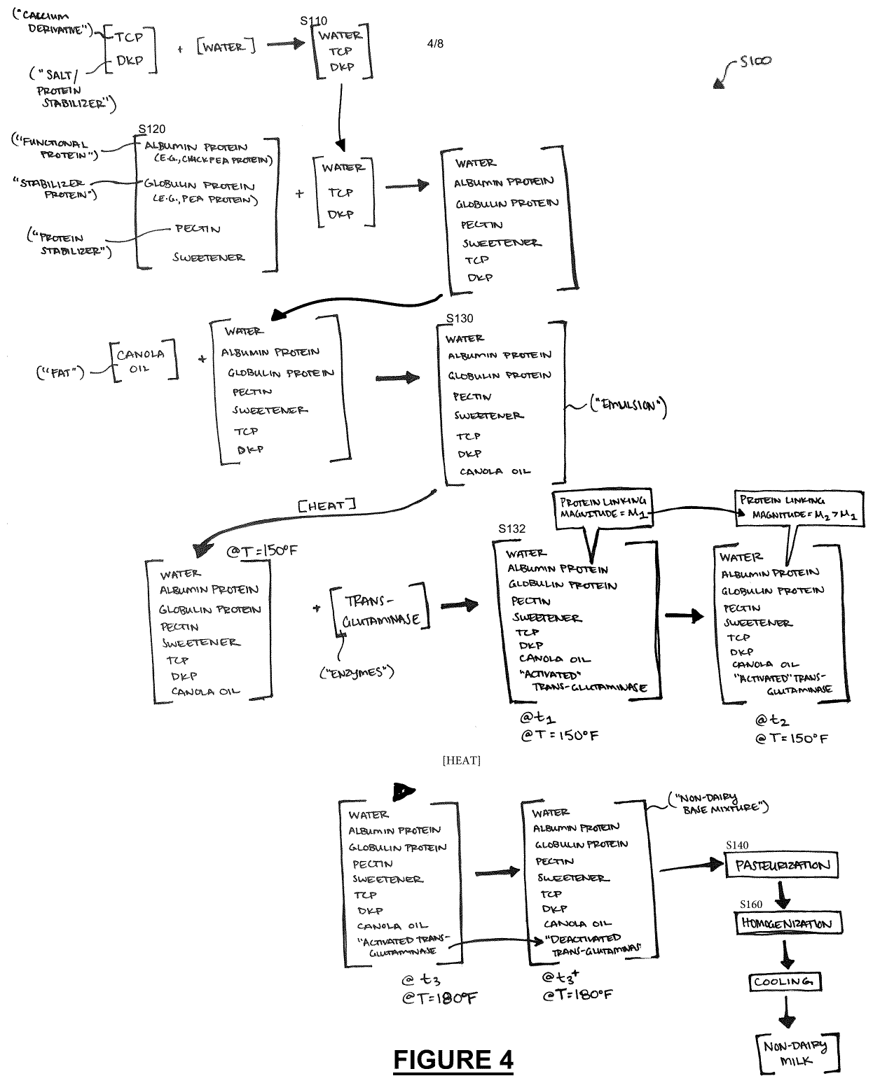

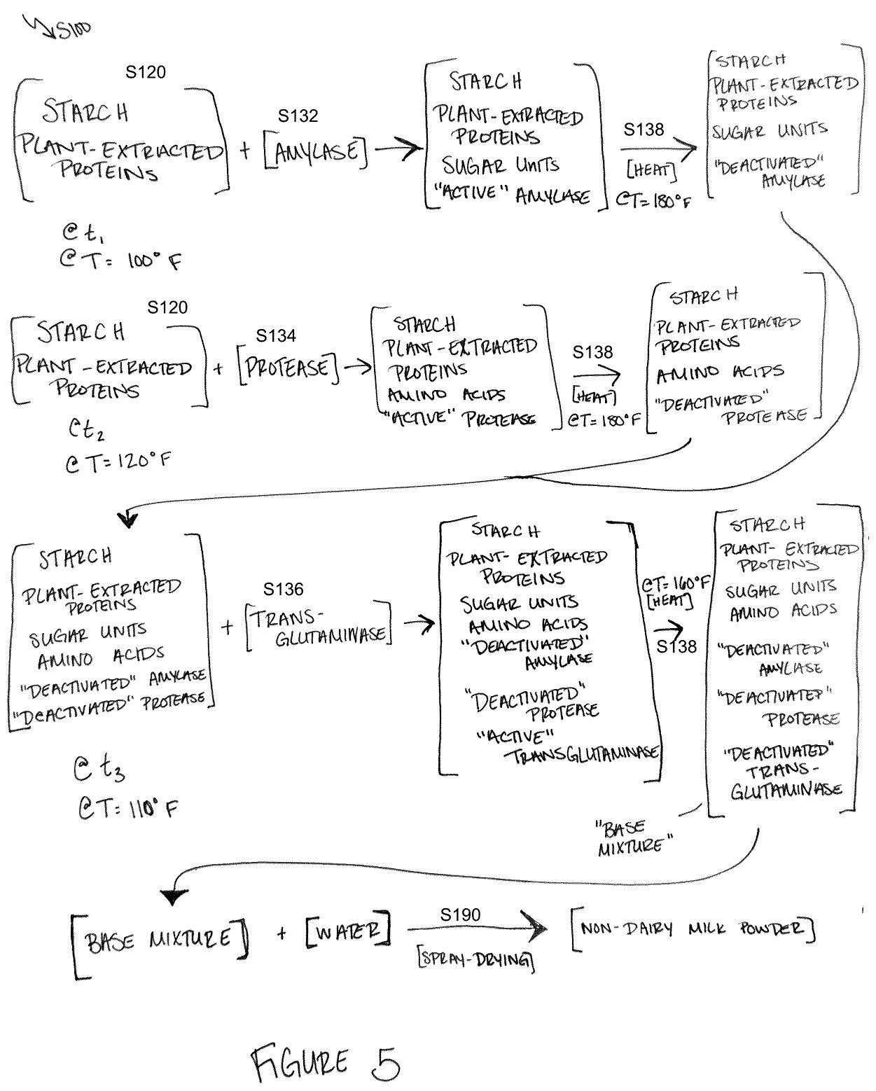

As shown in FIGS. 4, 5, and 6A-C, a non-dairy milk product 100 (or “base mixture”) includes: a first portion of a starch; a second portion of a plant-extracted protein 140; a third portion of sugar units 154 hydrolyzed from the starch 150 by a first enzyme 152; a fourth portion of amino acids 144 hydrolyzed from the plant-extracted protein 140 by a second enzyme 142; and a fifth portion of a protein matrix 148 synthesized from the plant-extracted protein 140 by a third enzyme 146.

1.1 Variation: Base Mixture with Enzymes

In one variation, as shown in FIGS. 4, 5, and 6A-C, a base mixture 100 includes: a first portion of a starch; a second portion of plant-extracted proteins 140; a first amount of a first enzyme 152 configured to catalyze hydrolysis of a first proportion of the first portion of the starch 150 into sugar units 154; a second amount of a second enzyme 142 configured to catalyze hydrolysis of a second proportion of the second portion of plant-extracted proteins 140 into amino acids 144; and a third amount of a third enzyme 146 configured to catalyze synthesis of protein bonds between plant-extracted proteins 140 in a third proportion of the second portion of the plant-extracted proteins 140 to form a protein matrix 148.

### 1.2 Variation: Emulsion

In another variation, as shown in FIG. 4, a base mixture 100 for the non-dairy milk product excludes dairy proteins and defines an emulsion configured to form a consumable, non-dairy product (e.g., non-dairy milk, non-dairy creamer, non-dairy ice cream, non-dairy cheese) exhibiting a target set of characteristics—including a target functionality and a target flavor profile-corresponding to a dairy product. The emulsion includes a blend including: an amount of water 110; an amount of salts 120 dissolved in the amount of water 110; an amount of calcium 130 dissolved in the amount of water 110; an amount of starches; an amount of sweeteners 160; an amount of plant-extracted proteins 140 including a proportion of albumin proteins defining the target functionality and a proportion of globulin proteins configured to stabilize the emulsion; and an amount of enzymes configured to promote formation of protein bonds between plant-extracted proteins 140 in the amount of plant-extracted proteins 140. The emulsion further includes an amount of fat 170 (e.g., fat globules) dispersed throughout the blend and configured to cooperate with the amount of plant-extracted proteins 140 to form the emulsion.

### 2. Method

As shown in FIG. 4, a method S100 includes: combining a first portion of a starch and a second portion of a plant-extracted protein 140 to form a first mixture in Block S120; and adding a first enzyme 152 to the first mixture to hydrolyze a first proportion of the starch 150 into a third portion of sugar units 154 in Block S132. The method S100 further includes adding a second enzyme 142 to the first mixture to hydrolyze a second proportion of the plant-extracted protein 140 into a fourth portion of amino acids 144 in Block S142 to form a second mixture including: the first portion of the starch 150; the second portion of the plant-extracted protein 140; the third portion of sugar units 154; and the fourth portion of amino acids 144. The method S100 further includes adding a third enzyme 146 to the second mixture to synthesize a fifth portion of a protein matrix 148 from a third proportion fourth the plant-extracted protein 140 in Block S136 to form a base mixture 100 including: the first portion of the starch 150; the second portion of the plant-extracted protein 140; the third portion of sugar units 154; the fourth portion of amino acids 144; and the fifth portion of the protein matrix 148.

As shown in FIG. 4, a variation of the method S100 for generating a non-dairy base mixture 100 (hereinafter a “base mixture”) includes, during a preparation period: mixing a first set of ingredients to generate a first mixture, the first set of ingredients including a volume of water 110, an amount of salt 120, and an amount of calcium 130 in Block S110; and mixing a second set of ingredients into the first mixture to generate a second mixture, the second set of ingredients including an amount of starches, an amount of plant-extracted proteins 140, and an amount of stabilizing agents configured to stabilize the amount of plant-extracted proteins 140, the amount of plant-extracted proteins 140 including a first amount of albumin proteins and a second amount of globulin proteins mixed at a particular ratio corresponding to a target functionality and a target flavor profile in Block S120. The method S100 further includes, during a blending period succeeding the preparation period: regulating temperature of the second mixture within a first temperature range; and blending a volume of oil into the second mixture to form an emulsion including a dispersion of oil droplets within the volume of water 110 in Block S.

The method S100 further includes: during an activation period succeeding the blending period, regulating temperature of the emulsion within a second temperature range associated with enzymatic activity of enzymes of a first type, and, at a first time, mixing an amount of enzymes of the first type (e.g., transglutaminase) into the emulsion to promote formation of protein bonds between plant-extracted proteins 140 in the amount of plant-extracted proteins 140 in Block S132; and, at a second time succeeding the first time by a fixed duration, increasing temperature of the emulsion to a temperature within a third temperature range-temperatures in the third temperature range exceeding temperatures in the second temperature range—to deactivate enzymes in the amount of enzymes in Block S138.

The method S100 further includes, during a pasteurization period succeeding the blending period, pasteurizing the emulsion at temperatures within a fourth temperature range and for a first duration in Block S140; and, during a homogenization period succeeding the pasteurization period, homogenizing the emulsion at temperatures within a third temperature range and for a second duration to form a base mixture 100 configured to form a consumable, non-dairy product exhibiting the target functionality and the target flavor profile in Block S160.

### 3. Applications

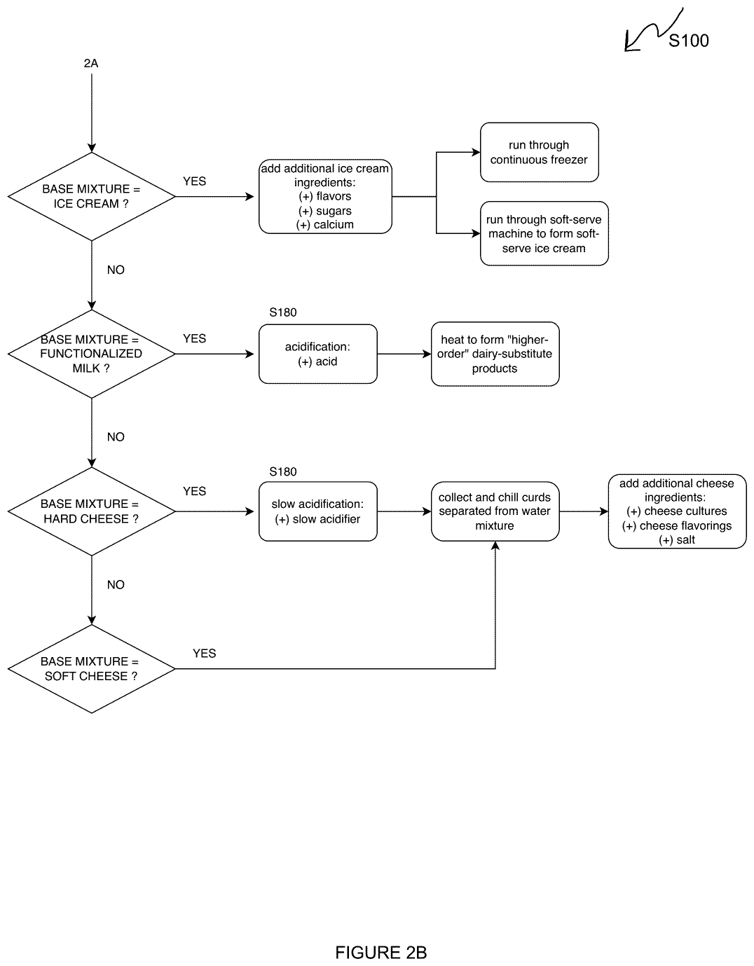

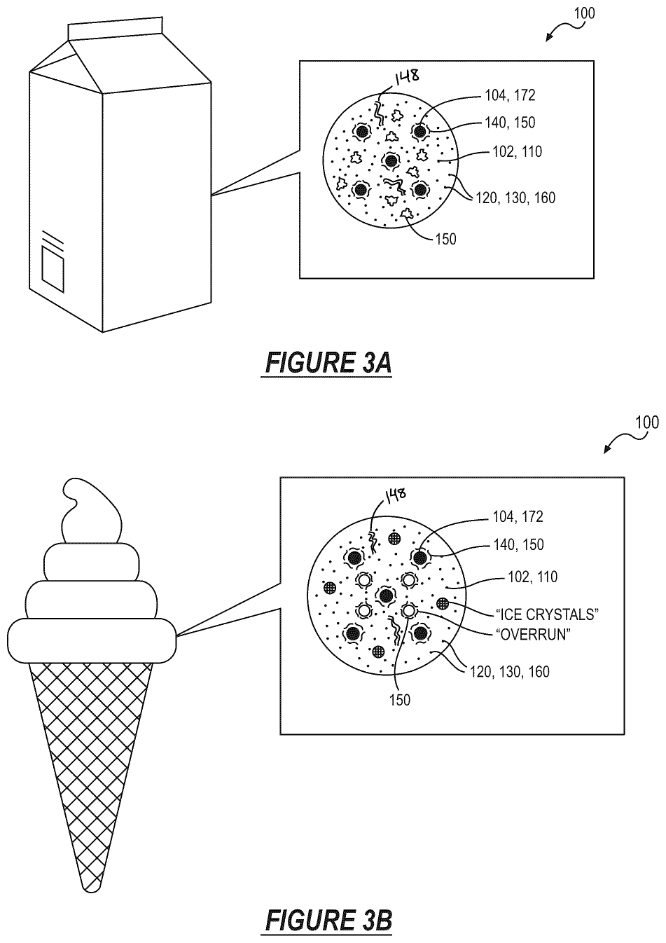

Generally, as shown in FIGS. 2A and 2B, a set of ingredients can be mixed to form a non-dairy milk product (hereinafter “base mixture”) 100 that can be processed further-according to various food processing techniques and/or in combination with additional ingredients—to form various dairy-alternative end products (e.g., excluding dairy proteins and excluding dairy ingredients), such as: a non-functional milk substitute for direct consumption; a functional milk substitute for baking, for at-home cheese-making, or that may be frothed; non-dairy frozen yogurt; non-dairy ice cream; non-dairy cream cheese; non-dairy soft cheese; non-dairy hard cheese; etc. The base mixture 100 can include: water 110, salt 120, calcium 130, sugars, proteins, and starches. These ingredients can be mixed in particular concentrations designated for the base mixture 100 (or at concentrations designated for a particular end product derived from the mixture) and processed at high sheer to form a homogeneous mixture.

These ingredients are then heated to a target temperature and emulsified with oil to reach a stable emulsion exhibiting substantially uniform oil droplet size (e.g., one to ten microns). This addition of oil to the homogeneous aqueous mixture initiates the formation of micelles in the resulting plant-based, non-dairy milk substitute. In particular, the base mixture 100 includes this set of ingredients and is processed to form micelles, which define microscopic structures that include hydrophobic and hydrophilic regions and are formed by aggregate surfactant molecules in aqueous solution, which enable the base mixture 100 to be transformed into many different forms, such as a non-dairy hard cheese, soft cheese, yogurt, cream, spread, ice cream, and/or butter, etc., much like a bovine milk. However, the base mixture 100 can include additional and/or any substitute ingredients to achieve qualities (e.g., taste, texture, functionality) of any other traditional dairy product. For example, the base mixture 100 can be configured to form a consumable, non-dairy product (e.g., non-dairy milk, non-dairy cream, non-dairy frozen dessert, non-dairy spreadable cheese) exhibiting a target flavor profile, a target texture profile, and/or a target color profile (or “pigment profile”) corresponding to a traditional dairy product.

Therefore, these ingredients can be combined in a particular sequence, at specific temperatures, and under particular conditions according to the method S100 in order to enable and control micelle formation within the resulting base mixture 100. In particular, rather than rely on micelles that are naturally present—in varying concentrations—in bovine milk (or milk from other animals) for functionality, and rather than filter or mix large batches of bovine milk in order to achieve consistent micelle concentrations across bovine milk products, the ingredients of the base mixture 100 can instead be combined according to the method S100 to yield any volume of base mixture 100 (e.g., from 10 grams to 10 cubic meters) with a consistent concentration (e.g., +/−0.1% by volume) of micelles.

Following micelle formation, this mixture can be homogenized in order to prevent phase separation and form a functionalized non-dairy base mixture 100. This functionalized non-dairy base mixture 100 can then be packaged and served directly to consumers, who may then froth (e.g., for coffee products), bake with, or make cheese with this functionalized non-dairy base mixture 100 in place of bovine milk (or milk from another animal). Additionally or alternatively, this functionalized non-dairy base mixture 100 can be selectively processed-such as with acidification or refrigeration processes-according to the method S100 in order to form other end products, such as: non-dairy ice cream; non-dairy cream cheese; non-dairy soft cheese; and non-dairy hard cheese.

For example, the base mixture 100 can include both an aqueous phase 102 and an oil phase 104, due to the addition of oil during emulsification of the base mixture 100. Starches present in the base mixture 100 stabilize the aqueous phase 102 of the base mixture 100 and thus maintain components of the mixture in a homogeneous suspension. A cassava base starch in the base mixture 100-which can exist in both the aqueous phase 102 and oil phase 104-stabilizes fats 170 in the oil. Proteins, which include both hydrophobic and hydrophilic tails, bind to both the aqueous phase 102 and the oil phase 104 in the mixture, thus forming a protective shell (or “barrier”) between oil droplets 172 of the oil phase 104 and water 110 and other components of the aqueous phase 102. This combination of proteins and starches thus enable emulsion of the oil into the aqueous phase 102 of the base mixture 100 via dispersion of oil droplets 172 throughout the aqueous phase 102 and to form a homogeneous mixture.

When the base mixture 100 (or emulsion) is acidified-such as by addition of lactic or citric acid, the proteins expel both water and oil and seek starches that are currently bound to oils in the emulsion. The starches in the water 110 phase thus separate to yield an aqueous phase 102 with salts 120, sugars, and starches. The resulting functionalized base mixture 100 can then be: chilled and processed in an ice cream machine to form ice cream; chilled, further acidified, and treated with an appropriate culture to form frozen yogurt; further chilled to form whipped topping; heated and further acidified before being chilled to form soft cheese (e.g., a mozzarella, cream cheese); or heated, further acidified, chilled, and then aged to form a hard cheese. These end products may therefore form non-dairy alternatives to traditional dairy products that exhibit similar functionalities, textures, stiffness, viscosities, thermo-reversibilities, and meltabilities as their dairy counterparts.

The base mixture 100 can be mixed to include additional ingredients-such as waxy maize, tapioca maltodextrin, natural flavors, and/or bioavailable trace minerals—such that resulting end products exhibit similar flavors and functionalities as their dairy counterparts.

### 3.1 Enzymatically Modified Non-Dairy Milk Products

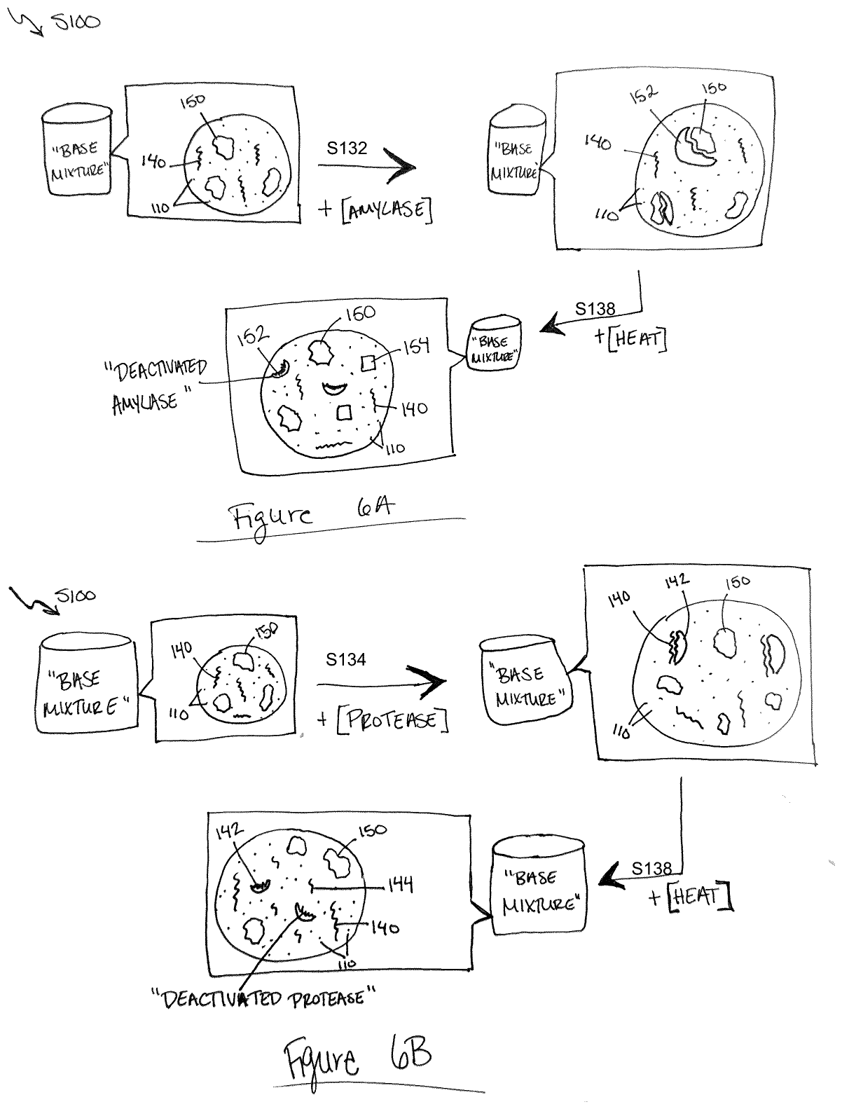

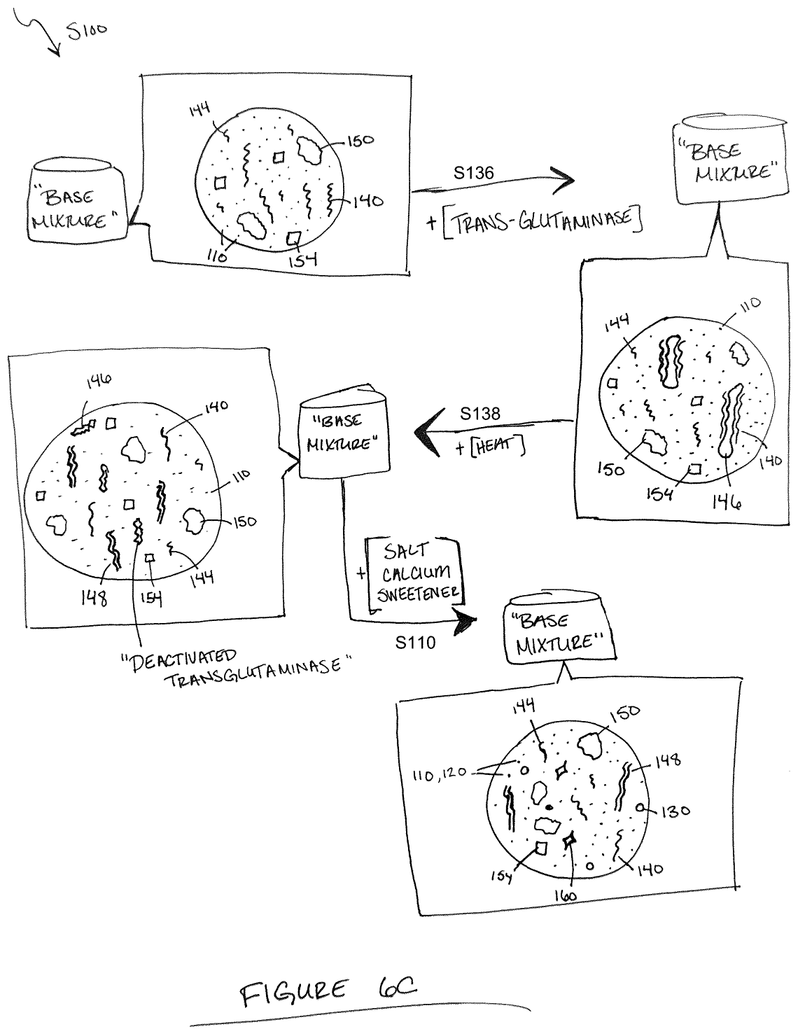

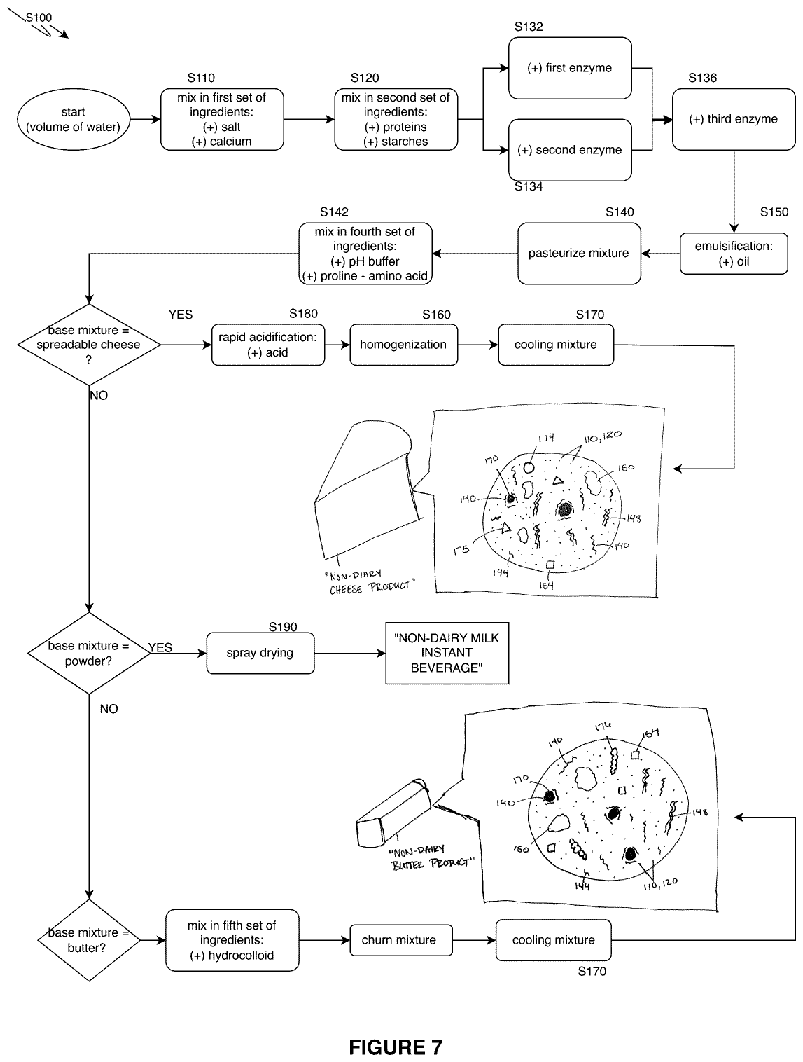

Generally, as shown in FIGS. 5 and 6A-C, a set of base ingredients (e.g., starch 150 and plant-extracted proteins 140) can be combined with a set of enzymes-such as in a particular order and for a target duration at a target temperature—to synthesize a non-dairy milk product excluding dairy products and including: starches 150; plant-extracted proteins 140; sugar units 154, amino acids 144; and a protein matrix 148 synthesized from plant-extracted proteins 140.

In particular, a portion of the starch 150 and a portion of the plant-extracted proteins 140 can be combined at a particular ratio to form a mixture. A first enzyme 152 (e.g., amylase) is then added to the mixture at a target temperature that yields increased enzymatic activity of amylase in order to hydrolyze a proportion of the starch 150 to produce sugar units 154. Similarly, a second enzyme 142 (e.g., protease) can be added to the mixture at a target temperature that yields increased enzymatic activity of protease in order to hydrolyze a proportion of the plant-extracted proteins 140 to produce amino acids 144 and/or peptides. The mixture is further heated to a deactivation temperature that denatures (or “deactivates”) amylase and protease enzymes in order to cease this enzymatic activity (i.e., reactions between these enzymes and the starch 150 and the plant-extracted proteins 140 in the mixture). These deactivated enzymes can then be filtered (i.e., removed) from the mixture.

A third enzyme 146 (e.g., transglutaminase) can then be added to the mixture to synthesize an amount of a protein matrix 148 from a proportion of the plant-extracted protein 140 in the mixture. In particular, following addition of the third enzyme 146, the mixture can be heated to a target temperature that yields increased enzymatic activity of transglutaminase and held at this target temperature for a target duration in order to synthesize a target proportion of protein matrix 148 in the mixture. The mixture can then be further heated to a second deactivation temperature that denatures transglutaminase in order to cease this enzymatic activity between transglutaminase enzymes and the plant-extracted proteins 140. The resulting protein matrix 148 may thus thicken the mixture to a target viscosity, texture, creaminess, and/or mouthfeel that approximates a dairy product, such as whole-fat dairy milk.

The mixture can then be processed as described herein-such as by emulsion, pasteurization, and/or homogenization—to produce a non-dairy milk product, such as: a non-functional milk substitute for direct consumption; a functional non-dairy milk substitute for baking or cheese-making; a functional non-dairy milk substitute that may be frothed (e.g., for an espresso-based beverage); a non-dairy frozen yogurt; a non-dairy ice cream; a non-dairy cream cheese; a non-dairy soft cheese; or a non-dairy hard cheese; etc.

In one example, following addition of amylase, protease, and transglutaminase enzymes, the mixture is emulsified with a portion of water 110 and oil 172 to promote the formation of micelles in the resulting plant-based, non-dairy milk substitute. In particular, the base mixture 100 includes this set of ingredients and is processed to form micelles (i.e., microscopic structures that include hydrophobic and hydrophilic regions and that are formed by aggregate surfactant molecules in aqueous solution).

In another example, the base mixture 100 forms a non-dairy milk powder configured to rehydrate in the presence of water 110 (or another liquid) to produce an instant non-dairy milk. In this example, the mixture is dried via spray drying or drum drying to form a non-dairy milk powder. This non-dairy milk powder may then be used in industrial applications, such as: as a bulking agent; as a tenderizing agent (in baking); and/or in an ice cream base.

### 3.2 Non-Dairy Base Mixture: Non-Dairy Analog+Target Characteristics

Generally, the base mixture 100 can be configured to form a consumable, non-dairy analog-such as a non-dairy milk, a non-dairy cream for coffee, a non-dairy frozen dessert (e.g., a non-dairy ice cream, a non-dairy frozen yogurt), a non-dairy yogurt, etc.—exhibiting a target set of characteristics defined for the non-dairy analog, such as including a target functionality, a target flavor profile, a target mouth-feel (or “texture”), and/or a target shelf life.

In particular, the base mixture 100 can include ingredients mixed at particular concentrations and processed according to particular operating parameters, such that—when fully processed to generate a non-dairy analog of a traditional dairy product—the resulting non-dairy analog mimics the taste, texture, functionality, and/or other characteristics of the traditional dairy product.

For example, the base mixture: can define a functional, non-dairy milk that may be consumed directly in place of animal (e.g., bovine) milk (e.g., in place of skim, 2%, or whole milk) and mimics the taste, texture, and/or functionality of animal milk; and can serve as a starting point for producing other non-dairy products. For example, a consumer may: purchase a carton of the functional milk product from a grocer; acidify all or a portion of this volume of the functional milk substitute; add a coagulant to the acidified functional milk substitute to trigger curdling; cut the resulting curd; stir, cook, and wash the curd; draw water 110 from the curds; and salt 120 and age the resulting mass, thereby transforming the functional milk substitute into a (hard) cheese at home, such as in a residential kitchen with a microwave or residential stove.

### 3.2.1 Foamable Non-dairy Milk

In another example, the base mixture 100 can define a functional, non-dairy milk exhibiting a target set of characteristics including: foam stability; heat stability (e.g., an upper coffee serving temperature of 175° F.); and pH stability in the presence of acid (e.g., chlorogenic acid in coffee). More specifically, in this example, the addition of the third enzyme (e.g., transglutaminase) can synthesize a protein network (or “matrix”) between plant-extracted proteins 140 in the functional non-dairy milk, which may: reduce surface tension in the functional non-dairy milk; increase water retention; and balance hydrophilic and hydrophobic properties of the plant-extracted proteins 140, thereby increasing foam stability by enabling the functional, non-dairy milk to maintain a “cold foam” structure. For example, reduced surface tension may enable the non-dairy milk to form a thin “film” around air bubbles in the foam, thus increasing the structural integrity of the foam. Furthermore, hydrophilic regions of the plant-extracted protein 140 in the functional, non-dairy milk may interact with a liquid stage of the foam, and hydrophobic regions of the plant-extracted protein 140 in the functional, non-dairy milk may interact with the gas stage of the foam. Strong cross-linking within the protein matrix 148—induced by the third enzyme (e.g., transglutaminase—may increase stability of these interactions and thus increase structural integrity of the foam.

Additionally, in this example, the functional non-dairy milk may be stable in higher-temperature and lower-pH environments, such as when the functional non-dairy milk is added to a hot coffee or hot tea beverage. In particular, the protein network (or “matrix”) between plant-extracted proteins 140 in the functional non-dairy milk synthesized by the third enzyme (e.g., transglutaminase) can: resist protein unfolding in the presence of temperature and/or pH increases; increase water retention; and increase emulsion stability.

Furthermore, under low pH (highly acidic) conditions and as plant-extracted proteins 140 in the functional non-dairy milk approach an isoelectric point of the plant-extracted protein 140, the protein matrix 148 can reduce mobility of plant-extracted proteins 140 and thus decrease a likelihood of coagulation (or “curdling”) of these proteins. Therefore, in this implementation, the addition of the third enzyme to the functional non-dairy milk can synthesize a stronger protein matrix 148 that: can withstand such in higher-temperature and lower-pH environments; prevents destabilization of proteins in the non-dairy milk and; and thus prevents curdling. This functional non-dairy milk may therefore exhibit viscosity, texture, creaminess, mouthfeel, foam stability, heat stability, and acid stability of a dairy milk or cream when added to a hot coffee or tea beverage.

### 4. Non-Dairy Base Mixture: Composition

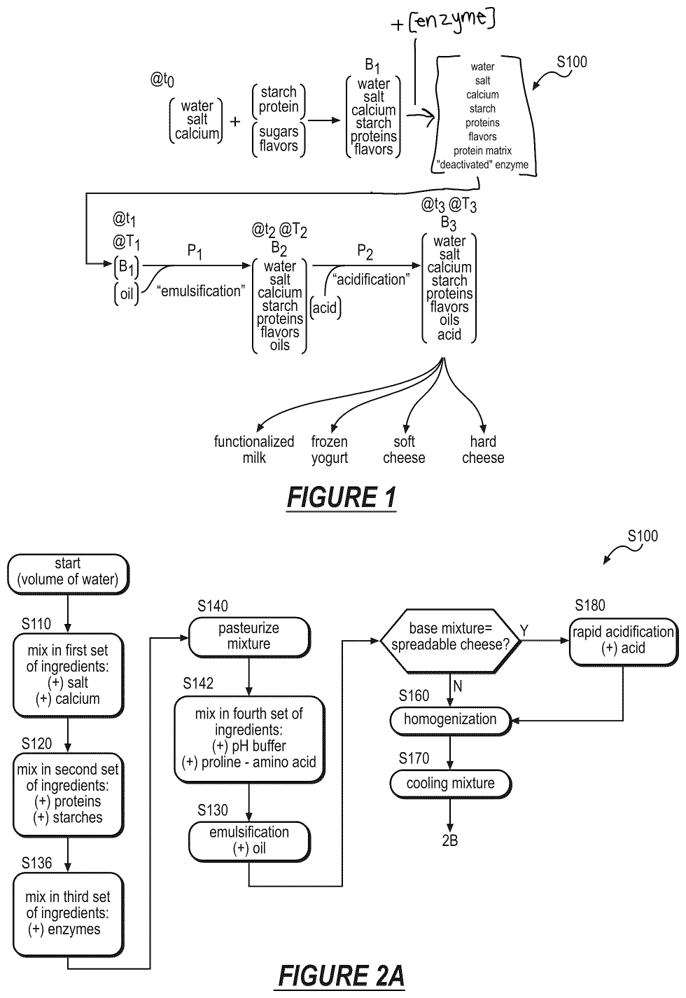

As shown in FIGS. 1 and 2, the base mixture 100 defines a homogeneous mixture of an aqueous phase defining a homogeneous suspension of solid particles and an oil phase defining a volume of oil droplets approximately uniformly distributed throughout the aqueous phase. Generally, the base mixture 100 includes a volume of water 110 and a set of ingredients—including an amount of salt 120, an amount of calcium 130, an amount of non-dairy proteins, an amount of starch, an amount of sweeteners 160, and/or an amount of fats 170-added to the volume of water 110. In particular, the base mixture 100 can define: an aqueous phase including the amount of salt 120, the amount of calcium 130, the amount of non-dairy proteins, the amount of starches 150, the amount of sweeteners 160; and an oil phase—including the amount of fats 170 (e.g., a volume of oil droplets 172)—dispersed within the aqueous phase. The base mixture 100 can be processed to form a homogeneous mixture including each of these ingredients.

In one implementation, the base mixture 100 defines a consumable, non-dairy milk (e.g., a non-dairy milk analog). In this implementation, the base mixture 100 can include: an amount of water 110; an amount of salt 120; an amount of calcium 130 (e.g., including calcium lactate and/or calcium gluconate); an amount of plant-extracted proteins 140-excluding dairy proteins-configured to impart a target functionality into the base mixture; an amount of starches including modified food starches and/or tapioca maltodextrin; an amount of sweeteners 160 including cane sugar, tapioca syrup, and/or vanilla extract; and an amount of fat 170 configured to cooperate with the amount of plant-extracted proteins 140 to impart a target flavor profile and/or target mouth-feel (or “texture”) into the base mixture. In this example, this base mixture 100 can be pasteurized, emulsified, homogenized, and/or cooled according to Blocks of the method S100 as described above. The base mixture 100 can then be stored (e.g., refrigerated) and/or consumed as a non-dairy milk product (e.g., a non-dairy milk-substitute product).

Additionally or alternatively, the base mixture 100 can include additional ingredients and/or undergo additional processing to generate additional non-dairy products from this non-dairy milk-substitute product. For example, the base mixture 100 can also include an amount of amino acids 144 configured to impart a particular set of characteristics-such as related to functionality, digestibility, and/or flavor—to the resulting base mixture, such that the resulting base mixture 100 exhibits a target functionality, digestibility, and/or flavor profile. Additionally and/or alternatively, in another example, the base mixture 100 can also include an amount of di-potassium phosphate configured to prevent phase separation of the aqueous phase and the oil phase of the base mixture 100 and, thereby, increase a shelf-life of the base mixture 100 and/or resulting non-dairy product.

### 4.1 Starch

Generally, the base mixture 100 includes a first portion of starch. The base mixture 100 includes the first proportion of starch configured to stabilize the aqueous phase 102 of the base mixture 100 when mixing in additional ingredients and more specifically when emulsifying the oil into the base mixture. The starch 150 stabilizes the aqueous phase 102 by promoting the homogeneous suspension of proteins and starches in the base mixture. By including starches configured to maintain this homogeneous suspension, the base mixture 100 can limit any phase separation, such that non-dairy end products exhibit smooth textures and consistencies similar to dairy counterparts.

The base mixture 100 can include different concentrations of starches to modify viscosity of the aqueous mixture. For example, the base mixture 100 can include a higher concentration of starch in the base mixture 100 configured to make ice cream, while the base mixture 100 can include a lower concentration of starch in the base mixture 100 configured to make yogurt. Thus, by including varying concentrations of starch, the base mixture 100 can exhibit different consistencies in the end product.

In one example, the first portion of the starch 150 can include a first proportion of potato starch. Additionally or alternatively, the base mixture 100 can include starches in other various forms including: cornstarch; cassava starch; waxy maize starch; tapioca maltodextrin; etc.

### 4.2 Plant-Extracted Proteins

Generally, the base mixture 100 can include an amount of plant-extracted proteins 140, such as configured to cooperate with the amount of fats 170 to form an emulsion that can be pasteurized and homogenized to form the base mixture.

In particular, the base mixture 100 includes the amount of plant-extracted proteins 140 including proteins extracted from non-dairy, plant-based sources (e.g., pea, chickpea, potato, rice, rapeseed, fava bean) and excluding dairy proteins (i.e., proteins derived from dairy milk)—such as casein proteins and/or whey proteins-such that the resulting base mixture 100 is non-dairy (i.e., excludes dairy ingredients). For example, the second portion of the plant-extracted protein 140 can include: a second proportion of functional albumin proteins; and a third proportion of stabilizing globulin proteins.

Furthermore, the base mixture 100 can be mixed to include the amount of plant-extracted proteins 140 extracted and/or processed according to a particular method S100 (e.g., matched to the target end product) and added at a particular concentration such that the resulting base mixture 100 exhibits a target functionality, flavor, color, and/or texture. Additionally or alternatively, the base mixture 100 can include an amount of plant-extracted proteins 140 corresponding to a target protein concentration defined for a non-dairy product formed of the base mixture, such as matching and/or falling within a threshold deviation of a standard protein concentration of a corresponding dairy analog.

### 4.2.1 Protein Selection: Target Characteristics

Generally, the base mixture 100 includes an amount of plant-extracted proteins 140 configured to impart a set of target characteristics-such as including a target functionality, a target flavor profile, and/or a target mouth-feel (or “texture”)—to a non-dairy product formed of the base mixture.

In one implementation, the base mixture 100 can include an amount of plant-extracted proteins 140 of multiple protein types configured to regulate functionality, flavor, and/or mouth-feel of the non-dairy product formed of the base mixture. In particular, in this implementation, the base mixture 100 can include an amount of plant-extracted proteins 140 including plant-extracted proteins 140 of a set of protein types and mixed at particular ratios configured to yield a target functionality, a target flavor profile, and/or a target mouth-feel for a volume of a non-dairy product formed of the base mixture.

For example, the base mixture 100 can include an amount of plant-extracted proteins 140 including a first proportion of proteins of a first protein type and a second proportion of proteins of a second protein type. The first proportion of proteins of the first type and the second proportion of proteins of the second type can be mixed at a target ratio associated with a target functionality and a target flavor profile defined for a non-dairy milk product (e.g., whole milk, skim milk, baking milk, milk for coffee) corresponding to a target non-dairy milk product. In this example, the proportion of plant-extracted proteins 140 can further include proportions of proteins of additional protein types. For example, the proportion of plant-extracted proteins 140 can include: a third proportion of proteins of a third protein type; a fourth proportion of proteins of a fourth protein type; a fifth proportion of proteins of a fifth protein type; etc. Each proportion of proteins, in the proportion of plant-extracted proteins 140, can be mixed at a particular ratio and configured to cooperate to achieve the target functionality, the target flavor profile, and/or the target mouth-feel defined for the consumable, non-dairy product.

### 4.2.2 Protein Blend: Functionality+Stability

In one implementation, the base mixture 100 can include an amount of plant-extracted proteins 140 including: a proportion of functional proteins (e.g., albumin proteins) configured to impart a target functionality to the non-dairy milk product formed of the base mixture; and a proportion of stabilizing proteins (e.g., globulin proteins) configured to stabilize the emulsion forming the base mixture, such as during pasteurization, homogenization, and/or further processing.

In particular, in one example, the base mixture 100 can include an amount of plant-extracted proteins 140 including: a proportion of albumin proteins extracted from a first plant source (e.g., pea, chickpea, rapeseed, rice, fava bean) and configured to impart a target functionality-such as characterized by a degree of foaming, gelling, and/or binding—to a non-dairy milk product formed of the base mixture; and a proportion of globulin proteins extracted from a second plant source (e.g., equivalent and/or different from the first plant source) and configured to stabilize the base mixture 100 and/or the resulting non-dairy milk product. In particular, the second proportion of globulin proteins can be configured to cooperate with fats 170 (e.g., oil droplets 172) present in the emulsion to prevent phase separation-such as due to flocculation, coalescence, and/or Ostwald ripening—and therefore stabilize the emulsion, such as during further processing (e.g., pasteurization, homogenization, heating and/or cooling) of the emulsion and/or the non-dairy product formed of the emulsion.

For example, the amount of plant-extracted proteins 140 can include: a proportion of pea proteins (i.e., proteins extracted from peas) exhibiting a target functionality; and a proportion of chickpea proteins (i.e., proteins extracted from chickpeas) configured to stabilize the emulsion forming the base mixture 100 and therefore preserve the target functionality exhibited by the proportion of pea proteins and prevent phase separation between the oil phase and aqueous phase of the emulsion. In another example, the amount of plant-extracted proteins 140 can include: a proportion of pea proteins exhibiting a target functionality; and a proportion of rice proteins (i.e., proteins extracted from rice) configured to stabilize the emulsion forming the base mixture. In yet another example, the amount of plant-extracted proteins 140 can include: a proportion of fava bean proteins (i.e., proteins extracted from fava beans) exhibiting a target functionality; and a proportion of chickpea proteins configured to stabilize the emulsion forming the base mixture.

In this implementation, the proportion of functional proteins can be mixed with the proportion of stabilizing proteins at a target ratio configured to achieve the target functionality, mouth-feel, and/or flavor profile defined for the non-dairy milk product formed of the base mixture.

### 4.2.2 Protein Stabilizers

In one variation, the base mixture 100 can include a proportion of protein stabilizers (hereinafter “stabilizing agents”) configured to stabilize proteins, in the proportion of plant-extracted proteins 140, within the base mixture 100 and/or non-dairy product formed of the base mixture. For example, the base mixture 100 can include a proportion of stabilizing agents-such as pectin, DKP, gellan gum, a hydrocolloid blend 176, etc.—configured to stabilize the amount of functional proteins, to prevent phase separation (e.g., during processing, throughout a shelf-life of the base mixture 100) and/or loss of protein functionality.

In one implementation, the proportion of protein stabilizers can include a proportion of a buffer configured to stabilize a suspension of particles in the emulsion forming the base mixture 100 and therefore stabilize a non-dairy product formed of the base mixture. For example, the base mixture 100 can define a non-dairy milk product (e.g., a creamer) configured for drinking and/or mixing with hot beverages (e.g., coffee, tea). The base mixture 100 can include a proportion of dipotassium phosphates (or “DKP”) configured to stabilize the proportion of plant-extracted proteins 140 arranged about and interfacing with fat droplets 170 distributed throughout the emulsion and therefore prevent syneresis when the non-dairy milk product is mixed with a hot beverage.

### 4.3 Enzymes

In one variation, the base mixture 100 can include an amount of enzymes configured to cooperate with the portion of plant-extracted proteins 140 and/or the portion of starches to achieve a target functionality, flavor, and/or texture (or “mouth-feel”) of a non-dairy product (e.g., a non-dairy milk) formed of the base mixture.

In particular, the base mixture 100 can include an amount of enzymes-proportional to the amount of plant-extracted proteins 140-configured to regulate protein structure of the amount of plant-extracted proteins 140 in the base mixture 100 and thus regulate characteristics (e.g., functionality, flavor, mouth-feel) of the resulting non-dairy product formed of the base mixture.

Additionally or alternatively, in this implementation, the base mixture 100 can include an amount of enzymes-proportional the amount of the plant-extracted proteins 140-configured to cooperate with the amount of fat 170 to achieve the target set of characteristics defined for the base mixture, such as without the need for fat 170 to be added to the base mixture 100 to achieve different flavor profiles, mouth-feels, and/or functionalities.

Similarly, in this implementation, the base mixture 100 can include an amount of enzymes-proportional the first portion of the starch 150-configured to cooperate with the starch 150 to achieve the target set of characteristics defined for the base mixture, such as by eliminating the addition of fat 170 and/or sweeteners 160 added to the base mixture 100 to achieve different flavor profiles, mouth-feels, and/or functionalities.

For example, the base mixture 100 can define a functional, non-dairy milk exhibiting a creamy mouth-feel and a rich flavor profile. In this example, the base mixture 100 can include: an amount of plant-extracted proteins 140 including a proportion of functional proteins and a proportion of stabilizing proteins; an amount of fat 170 corresponding to a maximum amount of fat 170 (e.g., one percent, four percent, ten percent) defined for the functional, non-dairy milk; and an amount of enzymes configured to—when heated and held at temperatures within a target enzymatic temperature range—promote binding between amino acid chains of functional proteins, in the proportion of functional proteins, thereby forming a proportion of enzymatically-modified proteins (e.g., derived from the proportion of functional proteins) defined by relatively-strong protein bonds between amino acid chains of these enzymatically-modified proteins. These enzymatically-modified proteins-derived from the proportion of functional proteins—can then cooperate with the amount of fat 170 to achieve the creamy mouth-feel and the rich flavor profile defined for the functional, non-dairy milk.

In the preceding example, without addition of the amount of enzymes, the resulting functional, non-dairy milk may exhibit a less creamy mouth-feel and/or a less rich flavor profile. Therefore, the base mixture 100 can be mixed to include this amount of enzymes in order to achieve the creamy mouth-feel and rich flavor profile without increasing the amount of fat 170-such as above the maximum amount of fat 170 defined for the functional, non-dairy milk-present in the base mixture, or by removing the amount of fat 170 altogether.

Furthermore, by promoting formation of strong bonds between proteins, in the proportion of plant-extracted proteins 140, the amount of enzymes can be configured to increase stability of the base mixture 100 and/or resulting non-dairy product formed of the base mixture. For example, the base mixture 100 can define a functional, non-dairy milk configured for direct human consumption and/or for mixing into hot beverages (e.g., coffee, tea). In this example, the base mixture 100 can be mixed to include an amount of plant-extracted proteins 140 and an amount of enzymes configured to promote formation of enzymatically-modified plant-extracted proteins 140-defining a quantity of relatively strong protein bonds—from the amount of plant-extracted proteins 140. Due to presence of these enzymatically-modified plant-extracted proteins 140 in the base mixture, the resulting functional non-dairy milk can exhibit relatively high stability when mixed into hot beverages, such as characterized by absence of curdling.

### 4.3.1 Amylase

In one implementation, the portion of sugar units 154 can be hydrolyzed from the starch 150 by the first enzyme 152 including an amylase enzyme (e.g., beta-amylase, gamma-amylase, fungal amylase, pancreatic amylase). More specifically, the third portion of sugar units 154 can be hydrolyzed from the starch 150 by the first enzyme 152 including an alpha amylase enzyme.

Furthermore, in this implementation, the amylase enzyme can cleave internal bonds in starch molecules in the first portion of starch molecules to hydrolyze a proportion of sugar units 154 (e.g., glucose, maltose).

More specifically, the third portion of sugar units 154 is hydrolyzed from the starch 150 by the first enzyme 152 cleaving glycosidic (e.g., alpha-1, 4-glycosidic) bonds between starch molecules in a first amount of the starch 150.

Thus, the amount of the first enzyme 152 (e.g., amylase) can hydrolyze additional sugar units 154 to: increase a perceived sweetness of an end product, without the addition of sweeteners 160; and achieve a target viscosity of an end product.

In one example, the third portion of sugar units 154 can be hydrolyzed from an amount of starch proportional to the first portion of starch. More specifically, the third portion of sugar units 154 is hydrolyzed from a first amount of the starch via addition of the first enzyme 152 to a mixture including the first portion of the starch 150 and the first amount of the starch 150, the first portion of the starch 150 greater than the first amount of the starch 150. For example, the first amount of starch 150 can represent a target proportion (e.g., 30 percent, 40 percent) of total starches in the base mixture, such that the first amount of starch 150 is completely hydrolyzed into sugar units 154. Therefore, the target proportion of total starches hydrolyzed into sugar units 154 to total starch composition of the base mixture 100 can: define a proportion of less than 1; achieve the target sweetness profile of the end product of the base mixture; and achieve the target mouthfeel of the end product of the base mixture.

In a similar example, the third portion of sugar units 154 can be hydrolyzed from the starch 150 by a first amylase enzyme (e.g., alpha amylase) and a second amylase enzyme (e.g., gamma amylase). In this example, the first amylase enzyme can cleave bonds within a first amount of the first portion of starch into a first proportion of maltose and a second proportion of glucose. The second amylase enzyme can further hydrolyze the first proportion of maltose into a third proportion of glucose units. Therefore, in this example, the first amylase enzyme and the second amylase enzyme can cooperate to hydrolyze a target proportion of maltose and glucose units to achieve a target sweetness profile of a non-dairy milk product and/or the base mixture.

### 4.3.2 Protease

In one implementation, the fourth portion of amino acids 144 can be hydrolyzed from the plant-extracted protein 140 by the second enzyme 142 including a protease (e.g., alcalase, papain, neutrase, trypsin, fungal protease A, savinase) enzyme. More specifically, the fourth portion of amino acids 144 can be hydrolyzed from the plant-extracted protein 140 by the second enzyme 142 including bromelain.

In this implementation, the fourth portion of amino acids 144 is hydrolyzed from the plant-extracted protein 140 by the second enzyme 142 cleaving peptide bonds between amino acids 144 in a second amount of the plant-extracted protein 140.

More specifically, a protease enzyme interacts with the portion of plant-extracted proteins 140 by binding with a particular peptide bond in plant-extracted proteins 140 and thereby cleaves the particular peptide bond to break down plant-extracted proteins 140 into amino acids 144 and/or peptide chains.

In one example, the fourth portion of amino acids 144 can be hydrolyzed by protease enzymes from an amount of plant-extracted protein proportional to the second portion of plant-extracted proteins 140. More specifically, in this example, the fourth portion of amino acids 144 is hydrolyzed from a second amount of the plant-extracted protein via addition of the second enzyme 142 to the mixture, further including the second portion of the plant-extracted protein 140 and the second amount of the plant-extracted protein, the second portion of the plant-extracted protein 140 greater than the second amount of the plant-extracted protein. For example, the second amount of plant-extracted protein can represent a target proportion (e.g., 20 percent, 30 percent) of total plant-extracted protein 140 in the base mixture, such that the second amount of plant-extracted protein is completely hydrolyzed into amino acids 144 (and peptides). Therefore, the target proportion of total plant-extracted protein hydrolyzed into amino acids 144 to total plant-extracted protein 140 composition of the base mixture 100 can: define a proportion of less than one; achieve the target flavor profile (e.g., umami flavor) of a target non-dairy milk product; and achieve a target viscosity of the target non-dairy milk product. Furthermore, the target proportion can define a proportion of less than one such that the amount of plant-extracted protein hydrolyzed into amino acids 144 is less than the second portion of plant-extracted proteins 140 such that there is a large amount (e.g., a third amount) of plant-extracted proteins remaining after protease reactions to allow for a third enzyme 146 (e.g., transglutaminase) to synthesize a protein matrix 148 from remaining plant-extracted proteins.

Furthermore, in this implementation, the base mixture 100 can include a sixth portion of water 110 that interacts with the plant-extracted proteins 140 and protease enzyme by, in response to a protease enzyme binding to a plant-extracted protein 140, cleaving the bond between two peptides in the plant-extracted protein 140.

Therefore, in this implementation, protease enzymes can: cleave plant-extracted proteins in the second portion of plant-extracted proteins 140 to hydrolyze the fourth portion of amino acids 144; and increase solubility of the base mixture.

### 4.3.3 Transglutaminase

In one implementation, the third enzyme 146 includes a transglutaminase enzyme, such as a plant-derived transglutaminase and/or a milk-derived transglutaminase configured to cooperate with the amount of plant-extracted proteins 140 to achieve the target functionality and/or target mouth-feel specified for the non-dairy milk product formed of the base mixture. In particular, the base mixture 100 can include an amount of transglutaminase configured to promote binding between amino acid chains of plant-extracted proteins 140 in the amount of plant-extracted proteins 140 and, thereby, regulate a protein structure of these plant-extracted proteins 140 and a functionality and/or mouth-feel exhibited by the resulting non-dairy milk product including the amount of plant-extracted proteins 140. More specifically, the fifth portion of the protein matrix 148 can be synthesized from the plant-extracted protein 140 by the third enzyme 146 including a transglutaminase enzyme. For example, the fifth portion of the protein matrix 148 can be synthesized from the plant-extracted protein 140 by the third enzyme 146 including a microbial transglutaminase enzyme.

In this implementation, the fifth portion of the protein matrix 148 is synthesized from the plant-extracted protein 140 by the third enzyme 146, catalyzing bond formation between plant-extracted proteins 140 in a third amount of the plant-extracted protein 140. More specifically, the third enzyme 146 (e.g., transglutaminase) catalyzes bond formation between glutamine and lysine residues in plant-extracted proteins 140 in a third amount of the plant-extracted protein 140 less than the second portion of the plant-extracted protein 140.

In one example, the fifth portion of the protein matrix 148 can be synthesized by transglutaminase enzymes from an amount of plant-extracted protein proportional to the second portion of plant-extracted proteins 140. In particular, in this example, the fifth portion of the protein matrix 148 is synthesized from a third amount of the plant-extracted protein via addition of the third enzyme 146 to the mixture further including the third amount of the plant-extracted protein, the third amount of the plant-extracted protein greater than the second amount of the plant-extracted protein 140.

For example, the third amount of plant-extracted protein can represent a target proportion (e.g., 50 percent, 70 percent) of total plant-extracted protein 140 in the base mixture, such that the third amount of plant-extracted proteins is: greater than the second amount of plant-extracted proteins hydrolyzed into amino acids 144, and therefore that the fifth portion of the protein matrix 148 is greater than the fourth portion of amino acids 144. In this example, the transglutaminase enzymes can: synthesize the fifth portion of the protein matrix 148 from the third amount of plant-extracted protein representing 50 percent to 70 percent of the remaining unhydrolyzed plant-extracted proteins. Furthermore, the target proportion can define an upper limit (e.g., 75 percent) of cross-linking between plant-extracted proteins 140 to synthesize the protein matrix 148.

In the foregoing example, the transglutaminase enzymes can synthesize the target proportion of plant-extracted proteins 140 into the protein matrix by defining a target temperature for a first time duration proportional to the target proportion and/or defining a target amount of transglutaminase enzymes proportional to the target proportion to achieve the target viscosity profile of the non-dairy milk product and avoid curdling in high-temperature environments. Thus, in this example, the base mixture 100 can define: a first portion of plant-extracted proteins 140 (e.g., 30 percent composition); a second portion of amino acids 144 synthesized from plant-extracted proteins 140 (e.g., 20 to 40 percent composition); and a third portion of the protein matrix 148 synthesized from plant-extracted proteins 140 (e.g., 50 to 70 percent composition).

Therefore, the target proportion of total plant-extracted proteins synthesized into the protein matrix 148 to total plant-extracted protein 140 composition of the base mixture 100 can contribute to target features of the non-dairy milk product formed from the base mixture: to achieve the target texture profile; and to achieve a target viscosity.

This implementation is described herein as using a basic transglutaminase enzyme. More specifically, the third enzyme 146 can define a transglutaminase enzyme including: a microbial transglutaminase sourced from microorganisms; animal-derived transglutaminase, such as sourced from bovine tissue; and/or plant-extracted transglutaminase. In one example, the third enzyme 146 includes an animal-derived transglutaminase. In this implementation, the first mixture includes: a portion of starch 150; a portion of plant-extracted proteins 140; and a portion of calcium 130. Furthermore, in this implementation, the portion of calcium 130 is proportional to the amount of animal-derived transglutaminase such that the portion of calcium 130 catalyzes (or “activates”) the animal-derived transglutaminase.

For example, the base mixture 100 can include an amount of a transglutaminase derived from plants (e.g., TI transglutaminase). In another example, the base mixture 100 can include an amount of transglutaminase derived from milk (e.g., milk-derived protein glutaminase). In this example, the base mixture 100 can be mixed to include the amount of milk-derived transglutaminase for a set duration during processing in order to promote generation of enzymatically-modified proteins in the base mixture. After this set duration-such as prior to pasteurization of the base mixture 100—the amount of milk-derived transglutaminase can be removed from the base mixture, such that the final, non-dairy base mixture 100 and/or resulting non-dairy product excludes milk-derived transglutaminase and/or any other milk-derived ingredient.

### 4.4 Salt

In one implementation, the base mixture 100 can include a portion of salt 120, such as dissolved in a volume of water 110. Salt 120 is initially added to water 110 to form an aqueous salt-water 110 mixture configured to hydrate proteins and starches of a protein-starch blend and promote unfurling of proteins. The base mixture 100 thus includes salt 120 to promote unfurling of proteins in an aqueous mixture of salt 120 and calcium 130 prior emulsifying oil into the aqueous phase 102.

Additionally, the base mixture 100 can include salt 120 to prevent proteins in the base mixture 100 from forming a solid gel. The salt 120 content can be adjusted to regulate an extent of protein gelation and a consistency of an end product produced by the base mixture. Thus, the base mixture 100 can include different concentrations of salt 120 for different end products to adjust consistency and texture of the base mixture 100 for a particular end product. For example, if the base mixture 100 designates whipped cream (i.e., a non-dairy whipped topping) as the end product, the base mixture 100 can include a relatively low proportion of salt 120-above a minimum threshold—for increased protein gelation and thus increased firmness of the whipped cream. However, if the base mixture 100 designates ice cream as the end product, the base mixture 100 can include a higher proportion of salt 120-below a maximum threshold—to achieve a creamier texture similar to a traditional dairy ice cream product.

In one implementation, the proportion of salt 120 dissolved in the volume of water 110 can be adjusted based on the isoelectric point of proteins in the proportion of proteins included in the base mixture. For example, a first batch (or “volume”) of the base mixture 100 can include: a first proportion of salt 120 dissolved in the volume of water 110; and a proportion of proteins defining a first isoelectric point. In this example, a second batch of the base mixture 100 can include: a second proportion of salt 120, less than the first proportion of salt 120, dissolved in the volume of water 110; and a proportion of proteins defining a second isoelectric point greater than the first isoelectric point.

Further, the base mixture 100 can include varying proportions of salt 120 to adjust freezing point temperatures and/or regulate freezing point depressions of end products. For example, for a base mixture 100 designating ice cream as an end product, a subvolume of the base mixture 100 can include a first proportion of salt 120 and exhibit a first freezing point. This first subvolume of the base mixture 100 may be packed in pint-size containers and stored in freezers at grocery stores. A second subvolume of the base mixture 100 can include a second proportion of salt 120 greater than the first proportion of salt 120 and exhibit a second freezing point less than the first freezing point. This second subvolume of the base mixture 100 may be stored in display freezers at ice cream shops, these display freezers maintained at lower temperatures than typical freezers at grocery stores. Thus, by including a higher salt 120 content, the base mixture 100 exhibits freezing point depression and can be stored at lower temperatures while maintaining similar consistency (e.g., for ease of serving or scooping ice cream).

### 4.5 Calcium

In one implementation, the base mixture 100 can include a portion of calcium 130. Calcium 130 is added to the aqueous salt-water mixture in preparation for addition of the protein-starch blend. Different forms of calcium 130 can be added to the salt-water mixture dependent on the specified end product. The base mixture 100 can include different forms of calcium 130 such as: calcium citrate, calcium lactate gluconate, calcium anhydrous chloride, calcium sulfate, tri-calcium phosphate, etc.

The base mixture 100 can include different forms and different concentrations of calcium 130 to regulate protein gelation and/or rigidity of the base mixture. As calcium 130 acts as a binder between the aqueous phase 102 and the oil phase 104 in the emulsion, the base mixture 100 can include different concentrations and types of calcium 130 in the mixture to adjust a degree and duration of binding between water 110 and oil droplets 172 in the base mixture. For example, a first subvolume of the base mixture 100 may designate a soft cheese as the end product. The first subvolume can include a first proportion of calcium 130. A second subvolume of the base mixture 100 may designate a hard cheese as the end product. The second subvolume can include a second proportion of calcium 130 greater than the first proportion of calcium 130, the second proportion of calcium 130 configured to promote binding between the aqueous phase 102 and the oil phase 104 of the base mixture 100 throughout an extended aging process of the hard cheese. Thus, by including a greater proportion of calcium 130, the second subvolume of the base mixture 100 exhibits stronger binding between the aqueous phase 102 and the oil phase 104 over an extended duration when compared to the first subvolume of the base mixture.

Additionally, the base mixture 100 can include different forms and concentrations of calcium 130 to regulate overrun in the end product.

### 4.6 Sweetener

In one implementation, the base mixture 100 can include a portion of sweetener 160. In addition to sugar units 154, the base mixture 100 can include a first proportion of sweetener 160 such as: sugar, glucose, dextrose, maltose, corn syrup, tapioca syrup, brown rice syrup, etc. In one implementation, the base mixture 100 includes a first proportion of sweetener 160 including a first quantity of sugar and a first quantity of glucose.

The base mixture 100 can include varying concentrations of sweeteners 160 configured to modify the taste and texture of the end product. For example, the base mixture 100 can include a portion of sweetener 160 proportional to the portion of sugar units 154 enzymatically hydrolyzed from starches in the base mixture. Therefore, in this example, the base mixture 100 can define a lower concentration of sweetener 160 than previously by relying on the portion of sugar units 154 enzymatically hydrolyzed from starches to achieve a target sweetness of the end product. The base mixture 100 includes sweeteners 160 (e.g., sugar, glucose) and other solids in the aqueous phase 102 of the base mixture. Inclusion of additional solids in the base mixture 100 increases stability and firmness of the aqueous solution. Thus, by including increased sweetener 160 concentration in the base mixture, the base mixture 100 can exhibit greater stability and better consistency.

### 4.7 Fat

In one implementation, the base mixture 100 includes a proportion of fat 170 (e.g., canola oil, sunflower oil, and/or safflower oil). The proportion of fat 170 may be the final ingredient added to the base mixture. Once the base mixture 100 reaches or exceeds a threshold temperature for emulsification, the oil may be added at a substantially consistent rate in order to generate uniform dispersion of approximately uniform oil droplets 172 172 (e.g., uniform shape, uniform size). The base mixture 100 includes a particular ratio of water 110 to oil such as to hydrate starches and sugars that compete for the same water 110 content. Additionally and/or alternatively, the non-dairy base mixture 100 can include a proportion of fat 170 corresponding to a standard proportion of fat 170 present in a corresponding dairy product. For example, the base mixture 100 can be configured to form a non-dairy whole milk product and can include a proportion of fat 170 (e.g., canola oil) such that the resulting non-dairy whole milk product includes approximately 4.30 percent fat 170 (e.g., within 0.50 percent). In another example, the base mixture 100 can be configured to form a non-dairy 2% milk product and can include a proportion of fat 170 such that the resulting non-dairy whole milk product includes approximately 2 percent fat 170 (e.g., within 0.10 percent). In yet another example, the base mixture 100 can be configured to form a non-dairy frozen dessert product (e.g., a non-dairy ice cream product) and can include a proportion of fat 170 such that the resulting non-dairy frozen dessert product includes between 16 percent fat 170 and 18 percent fat 170.

The base mixture 100 can include the proportion of fat 170 in the form of different oils depending on the specified end product. Fats 170 and oils with higher saturated fat 170 content may emulsify the base mixture 100 more readily and with greater consistency than fats 170 with lower saturated fat 170 content or unsaturated fat 170 content. For example, olive oil contains a low saturated fat 170 content and therefore may exhibit poor function as an emulsifier. Conversely, canola oil contains a high proportion of saturated fat 170 content and can therefore emulsify the mixture more quickly and consistently and can persist in dispersion with the aqueous phase 102 of the base mixture 100 over a longer duration of time than olive oil.

Additionally, the base mixture 100 can include both unsaturated fats 170 and saturated fats 170. For example, the base mixture 100 can include canola oil with high unsaturated fat 170 content and low saturated fat 170 content for the base mixture 100 configured to make ice cream. Alternatively, the base mixture 100 can include a rice bran oil with low unsaturated fat 170 content and high saturated fat 170 content for the base mixture 100 configured to make a hard cheese.

Additionally, the base mixture 100 can include additional fats 170 configured to cooperate with unsaturated fats 170 to act as substitute saturated fats 170. The base mixture 100 can include: monoglycerides; diglycerides; lecithin; etc.

Additionally or alternatively, the base mixture 100 can include a portion of fats 170 proportional to the portion of the protein matrix 148 enzymatically synthesized from plant-extracted proteins 140 in the base mixture. Therefore, in this example, the base mixture 100 can define a lower concentration (or amount) of fat 170 by relying on the protein matrix 148 to supply additional stability (e.g., creaminess, mouthfeel) to the end product.

### 5. Processing the Base Mixture

Generally, the base mixture 100 can be mixed to include a particular set of ingredients as described above, such as including: water 110, salts 120, calcium 130 (e.g., calcium 130 derivatives), starches, plant-extracted proteins 140, sugars, oil, protein stabilizers, and/or enzymes. The set of ingredients can be mixed at particular concentrations in order to yield the base mixture 100-configured to form a functional, non-dairy product-exhibiting a target functionality, flavor profile, mouth-feel, shelf life, etc., corresponding to the functional, non-dairy product.

In one implementation, the set of ingredients can be mixed at particular concentrations and in a particular order to generate an emulsion—such as by blending oil (i.e., fat 170) into an aqueous mixture including the amount of proteins-which can then be pasteurized, homogenized, and cooled to form a functional, non-dairy milk product.

In particular, in this implementation, a first set of ingredients—including a volume of water 110, an amount (e.g., proportion, concentration, weight) of salt 120, and an amount of calcium 130—can be mixed to form a first mixture during a preparation period. During the preparation period, a second set of ingredients—including an amount of starches, an amount of plant-extracted proteins 140, an amount of stabilizing agents configured to stabilize the amount of plant-extracted proteins 140, and/or an amount of sweeteners 160—can be mixed into the first mixture to form a second mixture. In particular, the amount of plant-extracted proteins 140 can include a first amount of canola proteins and a second amount of secondary proteins (e.g., rice proteins, chickpea proteins, fava bean proteins) mixed at a protein ratio corresponding to a set of characteristics (e.g., defined for a particular non-dairy product), such as including a target functionality, a target flavor profile, a target “mouth-feel” or texture, and/or a target appearance (e.g., color).

During a blending period succeeding the preparation period, the second mixture can be: held at temperatures within a first temperature range; and emulsified with a volume of oil. In particular, the volume of oil can be blended into the second mixture—at temperatures within the first temperature range—to form an emulsion including a dispersion of oil droplets 172 within the volume of water 110. During a pasteurization period succeeding the blending period, the emulsion (i.e., the base mixture) can then be pasteurized-such as according to a particular pasteurization process—at temperatures within a second temperature range and for a first duration defined for the particular pasteurization process. Finally, during a homogenization period succeeding the pasteurization period, the emulsion (i.e., base mixture) can be homogenized at temperatures within a third temperature range and for a second duration to form the base mixture 100 configured to form a consumable, non-dairy product (e.g., non-dairy milk, non-dairy yogurt, non-dairy ice cream) exhibiting the target set of characteristics, such as including the target functionality, the target flavor profile, the target “mouth-feel” or texture, and/or the target appearance.

### 5.1 Enzyme Addition

Generally, the method S100 can include: adding the first enzyme 152 to the first mixture at a first time; adding the second enzyme 142 to the first mixture at a second time; and adding the third enzyme 146 to the second mixture at a third time succeeding the first time and the second time.

In particular, the method S100 includes, at a first time, adding a target volume of an amylase enzyme to the first mixture. This target volume of the amylase enzyme hydrolyzes starch molecules in the base mixture 100 to form a third portion of sugar units 154. The method S100 also includes, during a second time, adding a target volume of a protease enzyme to the first mixture. This target volume of the protease enzyme hydrolyzes plant-extracted proteins 140 in the base mixture 100 to form a fourth portion of amino acids 144. Therefore, following the first time and the second time, the set of ingredients combined after the first and second time can define a second mixture including: the first portion of the starch 150; the second portion of the plant-extracted protein 140; the third portion of sugar units 154; and the fourth portion of amino acids 144.

The method S100 also includes, at a third time following the first time and the second time, adding a transglutaminase enzyme to the second mixture. The transglutaminase enzyme synthesizes the fifth portion of the protein matrix 148 from a (unhydrolyzed) proportion of the plant-extracted proteins 140.

Therefore, the amylase and protease enzymes may be added to the mixture prior to addition of transglutaminase and for particular time durations: to achieve a target product ratio of amino acids 144 and sugar units 154; and to achieve a target remainder of plant-extracted proteins 140 following addition of protease to enable transglutaminase to react with remaining plant-extracted proteins 140 to synthesize a target volume of the protein matrix 148.

Alternatively, if the transglutaminase enzymes are added to the mixture prior to addition of protease and/or amylase enzymes, the transglutaminase enzymes may synthesize the protein matrix from a proportion of the plant-extracted proteins 140 greater than the target proportion, such that the remainder of plant-extracted proteins 140 is insufficient for the protease enzyme to synthesize the target portion of amino acids. Accordingly, the protease enzymes are unable to cleave strong bonds between plant-extracted proteins 140 in the protein matrix. Therefore, the addition of transglutaminase enzymes to the mixture follows addition (and deactivation) of protease (and/or amylase) enzymes such that the transglutaminase enzymes may synthesize (or promote) strong bond formation between intact plant-extracted proteins 140 in the mixture.

### 5.2 Enzyme Activation & Deactivation

Block 138 of the method S100 recites, following an enzymatic activation period, increasing the temperature of the base mixture 100 to a second temperature outside of the activation temperature to denature (or “deactivate”) the enzymes. Specifically, in one variation, an amount of enzymes can be mixed with the portion of starch and the portion of plant-extracted proteins 140—at a target temperature for a target time period—to synthesize additional ingredients.

More specifically, the method S100 can include: holding the mixture at temperatures within an activation range for a first time duration; and, following the first time duration, increasing the temperature (e.g., outside of the activation range) to cease reactions between the amount of enzymes and the amount of plant-extracted proteins 140. In particular, during the first time duration, an enzyme (e.g., transglutaminase) synthesizes bonds between glutamine and lysine residues in plant-extracted proteins 140. Following the first time duration, the mixture may be increased to a second temperature exceeding the activation range (e.g., above F) to denature the transglutaminase and cease reactions between transglutaminase and plant-extracted proteins 140 in the mixture.

Additionally or alternatively, during the first time period, the mixture is held at a particular pH within a target pH range associated with increased enzymatic activity for transglutaminase (e.g., 5.0 to 8.0). In response to completion of the first time period, such as signaled by achieving a target amount of enzymatically-enhanced protein structures, the mixture can enter a pH environment outside of the target pH range (e.g., high alkaline conditions) to denature the transglutaminase and cease reactions between the transglutaminase and plant-extracted proteins 140 in the mixture.

In this variation, a set of enzymes can be added to the mixture in a particular order and at a particular proportion to achieve a target reaction rate and/or magnitude (e.g., product volume) between different enzymes in the set of enzymes and ingredients in the mixture. For example, the third portion of sugar units 154 is hydrolyzed from a first amount of the starch 150 via addition of the first enzyme 152 to a mixture, including the first portion of the starch 150 and the first amount of the starch 150, at a first time. Additionally, the fourth portion of amino acids 144 is hydrolyzed from a second amount of the plant-extracted protein 140 via addition of the second enzyme 142 to the mixture, further including the second portion of the plant-extracted protein 140 and the second amount of the plant-extracted protein 140, at a second time. The fifth portion of the protein matrix 148 is synthesized from a third amount of the plant-extracted protein 140 via addition of the third enzyme 146, to the mixture, further including the third amount of the plant-extracted protein 140, at a third time succeeding the first time and the second time.

More specifically, in this example, during a first time period of a first time period duration, the first enzyme 152, including an alpha amylase enzyme, is added to the first mixture including the portion of starch and the portion of plant-extracted protein 140. The first mixture is held within a target temperature range associated with increased amylase enzymatic activity (e.g., between 86° F. and 113° F.) for the first time period duration proportional to the target product amount of sugar units 154. Following the first time period, the temperature of the mixture is increased to a second temperature outside of the target temperature range (e.g., 170° F.) to denature (or “deactivate”) the amylase enzyme and cease enzymatic reactions of synthesizing sugar units 154.

During a second time period of a second time period duration, the second enzyme 142, including a protease enzyme, is added to the first mixture including the portion of starch and the portion of plant-extracted protein 140. The first mixture is then held within a target temperature range associated with increased protease enzymatic activity (e.g., between 110° F. and 125° F.) for the second time period duration proportional to target product volume of amino acids 144. Following the second time period, the temperature of the mixture is increased to a second temperature outside of the target temperature range (e.g., 170° F.) to denature the protease enzyme and cease enzymatic reactions of synthesizing amino acids 144.

During a third time period of a third time period duration and following the first and second time periods: the third enzyme 146, including a transglutaminase enzyme, is added to a second mixture including the portion of (unhydrolyzed) starch, the portion of (unhydrolyzed) plant-extracted protein 140, the portion of sugar units 154, and the portion of amino acids 144. The second mixture is then held within a target temperature range associated with increased transglutaminase enzymatic activity (e.g., 122° F. to 158° F.) for the third time period duration proportional to a target product amount (or volume) of protein matrix 148. Following the third time period, the temperature of the second mixture is increased to a second temperature outside of the target temperature range (e.g., 170° F.) to denature the transglutaminase enzyme and cease enzymatic reactions of synthesizing the protein matrix 148.

Therefore, the third (transglutaminase) enzyme can be incorporated into the mixture after the first (amylase) and second (protease) enzymes to: enable the first and second enzymes 142 to react with (e.g., “break down”) the starch 150 and the plant-extracted protein 140 to a target volume; and re-synthesize bonds between plant-extracted proteins 140 to further strengthen the resulting protein matrix 148.

The target temperature ranges, as described herein, can be adjusted based on a particular enzyme source and/or target temperature ranges associated with increased enzymatic activity characterized by the enzyme type.

The method S100 is described herein as denaturing (or “inactivating”) enzymes by adjusting (e.g., increasing) the temperature of the mixture to outside of the range of enzymatic activity. Additionally or alternatively, the enzymes can be denatured by: an extreme change in pH; implementing a chemical agent; and/or mechanical stress (e.g., blending, mixing).

In particular, in this variation, an amount of fat 170 (e.g., a volume of oil) can be emulsified into an aqueous blend—including water 110, salts 120, calcium 130 (e.g., calcium derivatives), starches, plant-extracted proteins 140, and/or sweeteners 160—to generate an emulsion (i.e., the base mixture). The amount of enzymes-configured to promote linking between amino acid chains of proteins in the aqueous blend—can then be mixed into the aqueous blend at a particular concentration corresponding to a target set of characteristics (e.g., a target functionality, flavor profile, mouth-feel) defined for a non-dairy product formed of the emulsion.

In one implementation, a first set of ingredients—including an amount of calcium 130 and an amount of salt 120—can be added to a volume of water 110 to generate a first mixture. A second set of ingredients—including an amount of starches, an amount of plant-extracted proteins 140, an amount of stabilizing agents, and/or an amount of sweeteners 160—can be mixed into the first mixture to generate a second mixture. The amount of fat 170 (e.g., canola oil, sunflower oil) can then be blended into the second mixture to generate an emulsion (i.e., the base mixture). The emulsion can then be heated to temperatures within a target temperature range—associated with activity of enzymes in the amount of enzymes—and the amount of enzymes can be added to the emulsion. The emulsion can then be held at temperatures within the target temperature range for a fixed duration in order to promote linking between protein molecules, in the amount of plant-extracted proteins 140, via enzymatic activity of enzymes of the amount of enzymes. In response to expiration of the fixed duration, the emulsion can be heated to a temperature exceeding a threshold temperature-defined for enzymes in the amount of enzymes—to deactivate enzymes in the amount of enzymes and therefore inhibit further enzymatic activity and/or linking between protein molecules via enzymatic activity. The emulsion—including inactive enzymes—can then be processed via pasteurization (e.g., HTST pasteurization, UHT pasteurization) and/or homogenization, as described above.

For example, an amount of transglutaminase enzymes can be mixed into the emulsion prior to pasteurization of the emulsion. In this example, the emulsion can include an amount of plant-extracted proteins 140 including an amount of albumin proteins-defining a target functionality—and an amount of globulin proteins configured to stabilize the emulsion. The amount of transglutaminase enzymes can be mixed proportional the amount of albumin proteins in the emulsion in order to achieve a target magnitude (e.g., quantity and/or strength) of protein bonds between amino acid chains of proteins in the amount of albumin proteins. Furthermore, prior to addition of the amount of transglutaminase enzymes to the emulsion, the emulsion can be heated to a first temperature (e.g., 65° F.) within a first temperature range (e.g., 60° F. to 80° F.) associated with enzymatic activity of transglutaminase enzymes. The amount of transglutaminase enzymes can then be added to the emulsion at the first temperature, and the emulsion—including the amount of (activated) transglutaminase enzymes—can be held at the first temperature for a fixed duration (e.g., five seconds, ten seconds, 30 seconds) to promote enzymatic activity of transglutaminase enzymes and therefore formation of protein bonds between amino acid chains of albumin proteins according to the target magnitude. In response to expiration of the fixed duration, the emulsion can be heated to a second temperature (e.g., 180° F., 190° F.) exceeding a threshold temperature (e.g., a maximum temperature)—associated with deactivation of enzymatic activity of transglutaminase enzymes—to inhibit further enzymatic activity and/or further bonding between proteins exceeding the target magnitude of protein bonding.

### 5.2.1 Enzymatic Activity: Hold Duration+Target Temperature

Generally, in the preceding variation, in response to addition of the amount of enzymes into the emulsion, the emulsion can be held at a temperature within a target temperature range and for a fixed duration in order to promote enzymatic activity and therefore promote formation of protein bonding (or “protein linking”) between plant-extracted proteins 140 present in the emulsion.

In one implementation, the emulsion—including the amount of enzymes mixed with the amount of plant-extracted proteins 140—can be held at a temperature within the target temperature range associated with enzymatic activity of enzymes in the amount of enzymes. In particular, in order to adjust a rate of enzymatic activity—and therefore a rate of protein bonding—the emulsion can be held at varying temperatures within this target temperature range.

For example, the method S100 can include adding the first enzyme 152 to the first mixture including: holding the first mixture at a first temperature for a first time duration, the first temperature falling within a first target enzymatic temperature range corresponding to the first enzyme 152; and increasing a temperature of the first mixture to a second temperature following the first time duration, the second temperature excluded from the first target enzymatic temperature range.

In this example, the method S100 can further include adding the second enzyme 142 to the first mixture including: holding the first mixture at a third temperature for a second time duration, the third temperature falling within a second target enzymatic temperature range corresponding to the second enzyme 142; and adjusting the temperature of the first mixture to a fourth temperature following the second time duration, the fourth temperature excluded from the second target enzymatic temperature range.

In this example, the method S100 further includes adding the third enzyme 146 to the second mixture including: adding the third enzyme 146 to the second mixture; holding the second mixture at a fifth temperature for a third time duration, the fifth temperature falling within a third target enzymatic temperature range corresponding to the third enzyme 146; and adjusting the temperature of the second mixture to a sixth temperature following the third time duration, the sixth temperature excluded from the third target enzymatic temperature range.

In the preceding example, the target temperatures and target time durations associated with adding the amount of enzymes can be adjusted to regulate the rate and/or magnitude of target enzymatic activity. In particular: the first time duration can be adjusted according to a target volume (or amount) of sugar units 154; the second time duration can be adjusted according to a target volume (or amount) of amino acids 144; and the third time duration can be adjusted according to a target rate (or magnitude) of formation of protein bonds between plant-extracted proteins 140 present in the emulsion. Furthermore, by regulating the enzymatic reaction rate and/or magnitude, the target temperatures and the target durations—in combination with the amount of enzymes added to the emulsion—can be adjusted based on a target set of characteristics (e.g., functionality, mouth-feel, flavor) defined for a non-dairy product formed of the mixture.

More specifically, volumes of the mixture (e.g., emulsion)—including the amount of enzymes mixed with the amount of plant-extracted proteins 140—can be held at temperatures within a target temperature range of 60° F. to 80° F. in order to promote enzymatic activity of these enzymes. In one example, a first volume of the emulsion can be held at a first temperature of 60° F.—associated with a first activity rate of enzymatic activity of enzymes—to promote formation of protein bonds at a first bonding rate proportional the first activity rate. Furthermore, a second volume of the emulsion can be held at a second temperature of 80° F.—associated with a second activity rate of enzymatic activity of enzymes and exceeding the first activity rate—to promote formation of protein bonds at a second bonding rate proportional the second activity rate and exceeding the first bonding rate.

Additionally or alternatively, in this implementation, the emulsion—including the amount of enzymes mixed with the amount of plant-extracted proteins 140—can be held at a temperature within the target temperature range and for a fixed duration configured to regulate a total magnitude (e.g., amount, strength) of protein bonding in the emulsion. In particular, in order to adjust a magnitude of protein bonding in the emulsion, the emulsion can be held within the target temperature range for varying durations.

For example, volumes of the emulsion—including the amount of enzymes mixed with the amount of plant-extracted proteins 140—can be held at temperatures within the target temperature range and for a duration within a duration range of five seconds to fifteen seconds in order to promote enzymatic activity of these enzymes. In one example, a first volume of the emulsion can be held at a first temperature of 65° F.—associated with a first activity rate of enzymatic activity corresponding to a first bonding rate of formation of protein bonds between plant-extracted proteins 140—for a first duration of five seconds in order to promote formation of protein bonds of a first magnitude (e.g., quantity, strength) between amino acid chains of the plant-extracted proteins 140 present in the emulsion. A second volume of the emulsion can be held at the first temperature of 65° F.—associated with the first activity rate of enzymatic activity corresponding to the first bonding rate—for a second duration of fifteen seconds in order to promote formation of protein bonds of a second magnitude (e.g., quantity, strength) between amino acid chains of the plant-extracted proteins 140 present in the emulsion, the second magnitude exceeding the first magnitude, such that the first volume of the emulsion defines a relatively lower magnitude of protein bonding and the second volume of the emulsion defines a relatively higher magnitude of protein bonding.

Furthermore, in the preceding example, a third volume of the emulsion can be held at a second temperature of 80° F.—associated with a second activity rate of enzymatic activity exceeding the first activity rate and corresponding to a second bonding rate exceeding the first bonding rate—for the first duration of five seconds in order to promote formation of protein bonds of the second magnitude between amino acid chains of the plant-extracted proteins 140 present in the emulsion, such that the third volume of the emulsion defines an (approximately) equivalent magnitude of protein bonding as the second volume of the emulsion.

For example, a first volume of the emulsion can be held at a first temperature of 65° F. for a first duration of ten seconds in order to promote formation of protein bonds of a first magnitude (e.g., quantity, strength) between amino acid chains of the plant-extracted proteins 140 present in the emulsion. The first volume can then be further processed-such as via deactivation of the amount of enzymes, pasteurization, and homogenization—to form a first volume of a base mixture 100 defining a first set of characteristics corresponding to the first magnitude of protein bonds. Furthermore, a second volume of the emulsion can be held at the temperature for a first duration of fifteen seconds in order to promote formation of protein bonds of a second magnitude (e.g., quantity, strength)—exceeding the first magnitude-between amino acid chains of plant-extracted proteins 140 present in the emulsion. The second volume can then be further processed-such as via deactivation of the amount of enzymes, pasteurization, and homogenization—to form a second volume of a base mixture 100 defining a second set of characteristics corresponding to the second magnitude of protein bonds. In particular, in this example, the first volume of the base mixture 100—including a relatively lower magnitude of protein bonds—can exhibit a less creamy mouth-feel, a less rich flavor profile, and a relatively lower degree of functionality. Alternatively, the second volume of the base mixture 100—including a relatively higher magnitude of protein bonds—can exhibit a creamier mouth-feel, a richer flavor profile, and a relatively higher degree of functionality.

### 5.3 Pasteurization

Block S140 of the method S100 recites pasteurizing the base mixture 100 and/or the emulsion. More specifically, the method S100 further includes, during a pasteurization period succeeding the blending period, pasteurizing the emulsion at temperatures within a first temperature range and for a first duration.

The third mixture can be heated to temperatures within the first temperature range (e.g., degrees-F to 200 degrees-F) and held in this second temperature range for a set duration (e.g., 20 minutes, 30 minutes, 1 hour) to pasteurize the third mixture. For example, the third mixture-defining a homogeneous suspension of salt 120, calcium 130, proteins, starches, and sugars in water 110—can be heated to a temperature of degrees and held at this temperature for a duration of 30 minutes. The third mixture can be pasteurized to eliminate harmful bacteria and/or other contaminants present in the third mixture before undergoing further processing. In particular, the third mixture—defining a homogenous suspension of salt 120, calcium 130, proteins, starches, and/or sugars in water 110—can be pasteurized according to a particular pasteurization process.

### 5.3.1 High-Temperature-Short-Time Pasteurization

In one implementation, the third mixture can be pasteurized via an HTST (or “high-temperature short-time”) pasteurization process. In this implementation, the third mixture can be: heated to a temperature within a high-temperature range (e.g., between 165° F. and 200° F.); and held at this temperature for a defined pasteurization duration (e.g., 25 seconds, 45 seconds, 1 minute). Upon expiration of the pasteurization duration, the third mixture can be run through a plate heat exchanger (e.g., within a threshold duration) to cool the third mixture to a temperature within a target temperature range (e.g., between 25° F. and 40° F.).

For example, the third mixture can be held at approximately (e.g., within five percent) 190° F. for a pasteurization duration of 25 seconds. In this example, the third mixture can then be cooled to a temperature of approximately (e.g., within 5 percent) 35° F. via running of the third mixture through a plate heat exchanger-such as within 10-15 seconds of expiration of the pasteurization duration
prior to homogenization of the third mixture.

Additionally and/or alternatively, in this implementation, the proportion of fats 170 (e.g., low-erucic rapeseed oil, sunflower oil, safflower oil) can be added to the mixture prior to pasteurization of the mixture. In particular, by pasteurizing the mixture at temperatures within a relatively high temperature range (e.g., between 165° F. and 200° F.) and therefore enabling pasteurization over a relatively short duration (e.g., less than 30 seconds, less than 25 seconds, less than 20 seconds), an extent (e.g., magnitude) of oxidation of unsaturated fats 170 present in the proportion of fats 170 can be reduced.

Additionally, in this implementation, the base mixture 100 can include the proportion of stabilizing agents configured to stabilize proteins, in the proportion of plant-extracted proteins 140, as described above. In particular, the proportion of stabilizing agents can be configured to stabilize proteins present in the base mixture 100 at relatively high temperatures during pasteurization. For example, the base mixture 100 can include a proportion of plant-extracted proteins 140 including a proportion of canola proteins defining a denaturation temperature falling below and outside of a target temperature range defined for the HTST pasteurization process. Therefore, in this example, the base mixture 100 can include a proportion of stabilizing agents-such as including pectin or sodium caprylate-configured to prevent denaturation of the proportion of canola proteins during the HTST pasteurization process.

In one variation, the base mixture 100 can be processed via an extended shelf-life (or “ESL”) process. In particular, in this variation, the base mixture 100 can be: heated to temperatures within a high, ESL temperature range-such as between 260° F. and 280° F.—defined for the ESL process; and held at this temperature for a defined ESL duration falling below the defined pasteurization duration. For example, the base mixture 100 can be heated to a temperature of approximately 277° F. (e.g., within 1 percent, within 5 percent) and held at this temperature for an ESL duration between 2.5 seconds and 6 seconds. In this variation, the proportion of fats 170 can similarly be added to the base mixture 100 prior to initiation of the ESL process. Further, the base mixture 100 can include a proportion of stabilizing agents configured to stabilize proteins (e.g., canola proteins) in the proportion of plant-extracted proteins 140 at temperatures within the ESL temperature range in order to prevent denaturation—and/or protein coagulation—and preserve functionality of these proteins.

Additionally, in another variation, the base mixture 100 can be processed via aseptic processing. In particular, in this variation, the base mixture 100 can be: heated to temperatures within a high, aseptic temperature range (e.g., between 250° F. and 300° F.) exceeding temperature ranges defined for the ESL process and the HTST pasteurization process; and held at this temperature for a defined aseptic processing duration falling below the defined pasteurization duration. For example, the base mixture 100 can be heated to a temperature of approximately 285° F. (e.g., within 1 percent, within 5 percent) and held at this temperature for an aseptic processing duration between 2.5 seconds and 6 seconds. In this variation, the proportion of fats 170 can similarly be added to the base mixture 100 prior to initiation of aseptic processing. Further, the base mixture 100 can include a proportion of stabilizing agents configured to stabilize proteins (e.g., canola proteins) in the proportion of plant-extracted proteins 140 at temperatures within the aseptic temperature range, in order to prevent denaturation—and/or protein coagulation—and preserve functionality of these proteins.

### 5.3.2 Low-Temperature, High-Duration Pasteurization

Alternatively, in another implementation, as shown in FIG. 5A, the third mixture—including salt 120, calcium 130, proteins, starches, and/or sugars in water 110—can be pasteurized according to a slow pasteurization process (e.g., a lower-temperature, higher-duration pasteurization process). In particular, in this implementation, the third mixture can be pasteurized at temperatures within a lower temperature range (e.g., between ° F. and 165° F.) and over a longer duration (e.g., exceeding 25 minutes). In one example, the third mixture can be held at approximately (e.g., within five percent) 156° F. for a duration of 30 minutes. In this implementation, the proportion of fats 170 (e.g., oil) can be added to the mixture after pasteurization of the mixture in order to limit oxidation of unsaturated fats 170 present in the proportion of fats 170.

### 5.3.3 Pasteurization Process Selection

The pasteurization process can be selected based on a type of processing (e.g., batch processing, semi-continuous processing) of the base mixture. In particular, in one example, volumes of the base mixture 100 can be processed via batch-processing. In this example, the base mixture 100 can be pasteurized according to the slow pasteurization process. Alternatively, in another example, volumes of the base mixture 100 can be processed via semi-continuous processing. In this example, the base mixture 100 can be pasteurized according to the HTST process.

Additionally and/or alternatively, the pasteurization process can be selected based on a target flavor of the resulting, non-dairy product (e.g., non-dairy milk, non-dairy whipped cream, non-dairy frozen dessert, non-dairy cheese). In particular, pasteurization at higher temperatures-such as according to the HTST pasteurization process—can reduce “grassy” flavors (e.g., via reduction of grassy volatiles in the mixture) in the mixture, thereby amplifying “buttery” flavors and/or “buttery” volatiles in the mixture. Therefore, a volume of the base mixture 100 configured to form a non-dairy product exhibiting increased “buttery” flavors can be pasteurized according to the HTST pasteurization process. Alternatively, a volume of the base mixture 100 configured to form a non-dairy product exhibiting reduced “buttery” flavors and/or increased “grassy” flavors can be pasteurized according to the slow pasteurization process.

Additionally and/or alternatively, this third mixture-defining a homogeneous suspension of salt 120, calcium 130, proteins, starches, and/or sugars in water 110—can be heated to a temperature within a temperature range and over a set duration according to a particular pasteurization process defined by characteristics of proteins in the proportion of proteins.

For example, the third mixture can include a proportion of Canola proteins (e.g., Napin proteins). During pasteurization, in order to limit denaturation of Canola proteins in the proportion of Canola proteins, the third mixture can be heated to a temperature within a temperature range (e.g., between 155° F. and 195° F.) and held at this temperature for a set duration (e.g., between 20 seconds and 40 minutes) based on times and temperatures at which Canola proteins exhibit denaturation. In particular, in this example, the third mixture—including a proportion of Canola proteins—can be pasteurized via HTST (or “high temperature short time”), such as by heating the third mixture to approximately 190° F. (e.g., within 5 degrees) for approximately of 25 seconds (e.g., within 2 seconds). Alternatively, in this example, the third mixture—including a proportion of Canola proteins—can be pasteurized by heating the third mixture to a temperature between 155° F. and 158° F. for a minimum of 30 minutes. Therefore, a duration of pasteurization can be adjusted by inversely adjusting the temperature of the pasteurization process.

In one variation, following pasteurization, a fourth set of ingredients can be added to the third mixture to generate a fourth mixture in Block S142. The fourth set of ingredients can include a first proportion of sodium bicarbonate and a first proportion of a basic amino acid (e.g., proline). The base mixture 100 can include this fourth set of ingredients to buffer a pH level of the base mixture, such that the pH level is increased and the base mixture 100 is less acidic. Additionally, the base mixture 100 can include this proportion of the basic amino acid to neutralize and/or counteract tannins present in proteins in the base mixture 100—in order to achieve a particular taste profile on the palate.

### 5.4 Emulsification

Block 130 of the method S100 recites emulsifying the base mixture 100 with a portion of oil. In particular, the base mixture 100, including these ingredients, is then heated to a target temperature and emulsified with oil to reach a stable emulsion. In this implementation, the base mixture 100 further includes: a sixth portion of water 110; and a seventh portion of plant-extracted oil droplets 172 dispersed throughout the sixth portion of water 110 and cooperating with the fifth portion of the protein matrix 148 and the sixth portion of water 110 to form an emulsion.

For example, the method S100 for generating a base mixture 100 can further include: adding a sixth portion of water 110 to the base mixture; and blending the base mixture 100 and the sixth portion of water 110 with a seventh portion of plant-extracted oil droplets 172 to form an emulsion. In this example, the base mixture 100 defines a powdered state. A sixth portion of water 110 can be added to the base mixture 100 to return the base mixture 100 to a liquid state. Following the addition of the sixth portion of water 110, the base mixture 100 can be blended with the seventh portion of plant-extracted oil droplets 172 to form the emulsion.

The base mixture 100 can thus undergo a high shear coarse emulsion to achieve this stable emulsion exhibiting substantially uniform oil droplet size (e.g., diameter less than 10 microns). For example, a base mixture 100 configured to make a non-dairy milk end product may exhibit substantially uniform oil droplet size between 4 microns and 6 microns. In one implementation, the base mixture 100 can be emulsified with the proportion of oil during an emulsification period succeeding pasteurization of the base mixture. Alternatively, in another implementation, the base mixture 100 can be emulsified with the proportion of oil during an emulsification period preceding pasteurization of the base mixture.

During emulsification, the base mixture 100—and, more specifically, the proteins in the base mixture 100—can be heated to a temperature above their isoelectric point, a temperature at which the proteins are stable (e.g., stay in suspension in the mixture). During this heating process, the oil is emulsified into the base mixture 100 at a steady rate to achieve a stable emulsion between the aqueous phase 102 and the oil phase 104 of the base mixture.

In one implementation, the base mixture 100 is heated to a first target temperature before adding in the oil. Upon reaching the first target temperature, a first proportion of oil is added to the base mixture. For example, a canola oil can be added to prepare the base mixture 100 for processing into whipped cream; and a rice bran oil can be added to prepare the base mixture 100 for processing into hard cheese. By adding the oil at the first target temperature, stability of the aqueous phase 102 of the mixture may increase, thereby enabling emulsion of the oil into the aqueous mixture to occur more readily and more consistently. The temperature of the mixture is then further increased to a second target temperature (e.g., approximately 176° F.) and held at this second target temperature for a target dwell time selected for the end product (e.g., between five and 27 minutes) such that the mixture is a homogeneous blend, stable, and fully emulsified. The temperature of the mixture is again increased to a peak temperature (e.g., approximately 167° F.); additional flavorings specific to the end product may then be added to the mixture occupying this third target temperature. Adding these flavorings to the mixture upon reaching this peak temperature and toward the end of this emulsification process may limit degradation of these flavorings due to excess temperature exposure during this temperature ramp.

This addition of oil to the homogeneous aqueous mixture initiates the formation of micelles in the resulting plant-based, non-dairy milk substitute. In particular, the base mixture 100 includes ingredients and is processed to form micelles, which define microscopic structures that include hydrophobic and hydrophilic regions and are formed by aggregate surfactant molecules in aqueous solution, which enable the base mixture 100 to be transformed into many different forms, such as a non-dairy hard cheese, soft cheese, yogurt, cream, spread, ice cream, and/or butter, etc., much like (traditional) animal milk.

Therefore, these ingredients can be combined in a particular sequence, at specific temperatures, and under particular conditions according to the method S100 in order to enable and control micelle formation within the resulting base mixture. In particular, rather than rely on micelles that are naturally present—in varying concentrations—in animal milk (e.g., bovine milk) for functionality, and rather than filter or mix large batches of bovine milk in order to achieve consistent micelle concentrations across bovine milk products, the ingredients of the base mixture 100 can instead be combined according to the method S100 to yield any volume of base mixture 100 (e.g., from 10 grams to 10 cubic meters) with a consistent concentration (e.g., +/−0.1% by volume) of micelles.

### 5.5 Variation: pH Regulation

In one variation, the base mixture 100 can include a proportion of a pH regulator configured to regulate pH of the base mixture 100 within a target pH range defined for the base mixture. In this variation, the proportion of the pH regulator can be added to the base mixture 100 upon completion of emulsification of the base mixture 100 to form the emulsion. The proportion of the pH regulator can, therefore, be selectively added to the emulsion (i.e., the base mixture) in order to maintain the pH of the emulsion within the target pH range.

In one implementation, the base mixture 100 can include a proportion of the pH regulator corresponding to target characteristics-such as functionality, mouth-feel, flavor, etc.—defined for the base mixture 100 and/or corresponding to a particular non-dairy product.

In one example, a first batch of the base mixture 100 can be configured to form a non-dairy milk product. Further, the base mixture 100 can be configured to exhibit a pH within a pH range of 6.3 to 6.5. In this example, upon completion of emulsification to form the emulsion, a pH level of the emulsion (i.e., the base mixture) can be measured. In response to the pH falling outside of the pH range, a proportion of a pH regulator-such as a potassium hydroxide solution configured to increase the pH or an acidifier configured to reduce the pH—can be added to the emulsion to selectively increase or decrease the pH to within the pH range, such as prior to pasteurization and/or homogenization. In this example, by maintaining the pH of the base mixture 100 within this pH range, the base mixture 100 can be configured to form the non-dairy milk product exhibiting a target functionality, such that the non-dairy milk product may be added to beverages of varying pH without exhibiting phase separation. In another example, a second batch of the base mixture 100 can be configured to form a non-dairy ice cream product. In this example, the base mixture 100 can be configured to exhibit a pH within a threshold deviation of 7.5. In response to the pH level falling below and outside the threshold deviation of 7.5, a proportion of potassium hydroxide solution-such as a trace amount—can be added to the emulsion to increase the pH to within the threshold deviation of 7.5, such as prior to pasteurization and/or homogenization.

### 5.6 Homogenization

Block 160 recites, during a homogenization period, homogenizing the base mixture 100 at a particular temperature. Following emulsification of the oil into the base mixture, the base mixture 100 can be homogenized in order to prevent phase separation and form the functionalized non-dairy base mixture. More specifically, the method S100 includes, during a homogenization period succeeding the pasteurization period (and/or the emulsification), homogenizing the emulsion at temperatures within a second temperature range and for a second duration.

More specifically, the base mixture 100 is homogenized to achieve uniform particle distribution, particle size, fat 170 globule distribution, and fat 170 globule size, each of which may cooperate to prevent phase separation within the base mixture 100 and promote a consistent base mixture. The base mixture 100 can be configured to exhibit particle and fat 170 distribution and sizes substantially similar to dairy counterparts.

In one variation, the base mixture 100 is cooled from higher temperatures during emulsification to lower temperatures (e.g., less than 40° F.) prior to homogenization of the base mixture.

The base mixture 100 can be homogenized within a set duration following emulsification, such as to limit reactions occurring between ingredients in the base mixture. For example, a proportion of amino acids 144 may interact with sugar in the base mixture 100 to generate molotol at particular temperatures and over a period of time. Thus, the base mixture 100 can be homogenized rapidly following emulsification of the base mixture 100 to limit molotol generation (e.g., malty flavors) in the base mixture.

The base mixture 100 can be homogenized via a triple plate homogenizer at a set (e.g., relatively high) temperature. For example, the base mixture 100 can be homogenized via a triple plate homogenizer operating between 800-2200 psi. Alternatively, the base mixture 100 can be homogenized via ultrasonic homogenization or cavitation homogenization.

### 5.7 Cooling & Further Processing

Block 170 of the method S100 recites, following homogenization, if not previously cooled, the base mixture 100 can be rapidly cooled from high temperatures during homogenization to lower temperatures (e.g., less than 40° F.). The base mixture 100 can be cooled via a heat exchanger. For example, the base mixture 100 can be run through a plate heat exchanger to reduce a temperature of the base mixture 100 from approximately (within 10° F.) ° F. during homogenization to approximately (within 10° F.) 38° F. following cooling. The base mixture 100 can be cooled quickly (within a set duration following homogenization) in order to limit side reactions between ingredients (e.g., proline and sweeteners 160 generating malt flavors).

In one variation, to produce a higher-order dairy product from the functional base mixture, such as a whipped cream or cheese, an acid can be added (e.g., in trace amounts) to the base mixture. Depending on the selected higher-order dairy product, the acid can be introduced before increasing the temperature of the base mixture 100 and emulsifying in the oil (e.g., cream cheese) or the acid can be introduced after emulsification and after the mixture is allowed to cool (e.g., frozen yogurt, feta cheese, or cheddar cheese). For example, a moderate proportion of acid 174 (e.g., 0.2% by weight) can be added to the base mixture 100 when transforming the base mixture 100 into a soft cheese, and a smaller proportion of acid 174 (e.g., 0.1% by weight) can be added to the base mixture 100 when transforming the base mixture 100 into a hard cheese or other end product.

### 5.7.1 Storing the Base Mixture

The resulting base mixture 100 can be further processed and/or stored according to a set of storage conditions defined for the base mixture. In particular, the base mixture 100 can define a set of storage conditions configured to: maximize a shelf-life of the base mixture; and maintain and/or promote a set of target characteristics-such as the target flavor profile, target functionality, target texture or “mouth feel”, etc.—of the base mixture.

In one variation, Block 190 of the method S100 recites, prior to packaging and/or storing of the base mixture 100, spray-drying the base mixture 100 to transform the base mixture 100 into a solid or powdered form. In this variation, the base mixture 100 can be reconstituted-such as by mixing the base mixture 100 with a volume of water 110—to return the base mixture 100 to a liquid or semi-liquid form. In this variation, the method S100 of synthesizing the base mixture 100 can include: spray-drying a volume of the base mixture 100 to transform the base mixture 100 into a powdered state; and packaging the volume of the base mixture 100 in the powdered state for storage.

More specifically, in this variation: the third portion of sugar units 154 is hydrolyzed from a first amount of the starch 150 via addition of the first enzyme 152 to a mixture, including the first portion of the starch 150 and the first amount of the starch 150, in presence of water 110; the fourth portion of amino acids 144 is hydrolyzed from a second amount of the plant-extracted protein 140 via addition of the second enzyme 142 to the mixture, further including the second portion of the plant-extracted protein 140 and the second amount of the plant-extracted protein 140, in presence of water 110; the fifth portion of the protein matrix 148 is synthesized from a third amount of the plant-extracted protein 140 via addition of the third enzyme 146, to the mixture further including the third amount of the plant-extracted protein 140, in presence of water 110; and the first portion of the starch 150, the second portion of the plant-extracted protein 140, the third portion of sugar units 154, the fourth portion of amino acids 144, and the fifth portion of the protein matrix 148 are dried to form the non-dairy milk product including a non-dairy milk powder.

In one implementation, to prevent destabilization of proteins in the proportion of plant-extracted proteins 140, the base mixture 100 can be: pasteurized via a low-temperature, high-duration pasteurization process configured to limit destabilization of plant-extracted proteins 140 (e.g., canola proteins); and then spray-dried—at relatively high temperatures—to transform the base mixture 100 from a liquid form to a powdered form. In this implementation, in order to limit a duration of exposure of the base mixture 100 to high temperatures, the base mixture 100 can be processed via this lower-temperature pasteurization process. The base mixture 100 can then be further processed by spray drying the (liquid) base mixture 100-such as at relatively high temperatures—to yield the base mixture 100 in the powdered form and further extend the shelf life of the base mixture.

Additionally, in one implementation, the base mixture 100 can be mixed with a volume of a buffer solution matched to the base mixture 100 and then spray dried (and/or freeze dried) to generate a dried base mixture 100-such as the base mixture 100 in solid or powdered form—in preparation for storage. For example, in this implementation, the base mixture 100 further includes a sixth portion of a carbohydrate to stabilize (e.g., increase the shelf life of) the non-dairy milk powder. More specifically, the base mixture 100 can include a stabilizing agent (e.g., maltodextrin) configured to: cooperate with the base mixture 100 to form a powdered non-dairy milk product; and decrease hygroscopicity (moisture absorption) of the powdered non-dairy milk product.

This dried base mixture 100 can then be stored according to a set of storage conditions defined for the base mixture, such as at temperatures within a target temperature range configured to maintain functionality, flavor, texture, and/or appearance of the base mixture 100—and/or the non-dairy product formed of the base mixture 100—for a target duration or “shelf life.” Additionally, in this implementation, a set of stabilizing agents (e.g., stabilizing ingredients) can be added to the base mixture 100 and/or to the dried base mixture 100 in order to prolong stability of the proportion of plant-extracted proteins 140. For example, various proteins or sugars can be added to the base mixture 100 and/or to the dried base mixture.

### 6. Functional, Non-dairy Milk

In one implementation, as shown in FIG. 4, the base mixture 100 can define a non-dairy milk substitute exhibiting a target functionality, such that the non-dairy milk may be directly consumed, frothed in a hot beverage, implemented as a baking ingredient, and/or processed further for at-home cheese making.

Generally, in this implementation, the base mixture 100 includes a set of ingredients including: water 110, salt 120, calcium 130, starches 150, plant-extracted proteins 140 (e.g., chickpea protein, pea protein, rice protein, canola protein, potato protein, fava bean protein), protein-stabilizers (e.g., pectin), enzymes, sugars, and fat 170 (e.g., oil). These ingredients can be mixed in a particular order and at particular concentrations to form an emulsion that can be further processed-via pasteurization, homogenization, and/or cooling—to form the non-dairy milk substitute.

More specifically, the base mixture 100 can include a proportion of plant-extracted proteins 140—including a mixture of albumin proteins (e.g., chickpea proteins) and globulin proteins (e.g., pea proteins, fava bean proteins)—configured to cooperate with ingredients in the base mixture 100 to regulate a functionality, mouth-feel, and/or flavor profile exhibited by the resulting non-dairy milk substitute formed of the base mixture. In particular, the proportion of plant-extracted proteins 140 can include: an amount of albumin proteins configured to impart a target functionality-characterized by binding, foaming, gelling, solubility, and/or micelle formation—to the base mixture 100 and resulting non-dairy milk; and an amount of globulin proteins configured to stabilize the emulsion during processing and/or throughout a target shelf-life of the non-dairy milk.

Furthermore, during processing, a proportion of enzymes (e.g., transglutaminase enzymes) can be added to the base mixture 100 to: promote linking between amino acid chains of proteins (e.g., albumin proteins) in the proportion of plant-extracted proteins 140; and, thereby, regulate characteristics-such as including functionality, stability, texture, and/or flavor—of the resulting non-dairy milk. The proportion of enzymes added to the base mixture 100 can be modified in order to regulate these characteristics of the non-dairy milk. In particular, a relatively high proportion of enzymes can be added to the base mixture 100 to achieve a relatively high rate of enzymatic activity—and thereby achieve a relatively higher magnitude of protein linking between albumin proteins in the base mixture 100—to form a base mixture 100 defining a non-dairy milk characterized by a “creamy” mouth-feel, a “rich” flavor profile, and a relatively high-degree of functionality (e.g., foaming, gelling), such as similar to a high-fat 170 dairy milk (e.g., a dairy milk exceeding four percent fat 170). Alternatively, a relatively low proportion of enzymes can be added to the base mixture 100 to achieve a relatively low rate of enzymatic activity—and thereby achieve a relatively lower magnitude of protein linking—to form a base mixture 100 defining a non-dairy milk characterized by a “less-creamy” mouth-feel, a “less-rich” flavor profile, and/or a relatively low-degree of functionality, such as similar to a low-fat 170 dairy milk (e.g., a dairy milk including less than four percent fat 170).

The base mixture 100 can therefore be processed to include a varying concentration of enzymatically-modified proteins—including plant-extracted albumin proteins defining an array of protein bonds formed via addition of the proportion of enzymes to the base mixture 100—to achieve varying functionality, flavor, and/or mouth-feel in the resulting non-dairy milk and therefore account for varying flavor and/or mouth-feel preferences of consumers, without modifying fat 170 content of the base mixture. For example, rather than increase a proportion of fat 170 added to the base mixture 100 in order to achieve a richer, creamier, non-dairy milk, the proportion of enzymes added to the base mixture 100 can be increased to increase rate of formation of enzymatically-modified proteins in the base mixture.

Additionally, the proportion of enzymes can be added to the base mixture 100 in a particular concentration, at a particular temperature, and over a particular duration, in order to regulate an extent or “magnitude” of formation of protein bonds between plant-extracted proteins 140 in the base mixture, and, thereby, regulate functionality of the resulting non-dairy milk. For example, a first batch of the base mixture 100 can be configured to include a first proportion of enzymatically-modified proteins—formed via formation of protein bonds between amino acid chains of proteins in the proportion of plant-extracted proteins 140 in response to addition of the proportion of the enzymes-defining a first magnitude of protein bonds. This first batch of the base mixture 100 can define a non-dairy milk-defining a relatively low functionality-configured for direct consumption. Additionally, a second batch of the base mixture 100 can be configured to include a second proportion of enzymatically-modified proteins-formed via formation of protein bonds between amino acid chains of proteins in the proportion of plant-extracted proteins 140 in response to addition of the proportion of the enzymes-defining a second magnitude of protein bonds. This second batch of the base mixture 100 can define a non-dairy milk-defining a relatively high functionality—configured for mixing and/or frothing in hot beverages (e.g., coffee, tea), such that the non-dairy milk exhibits stability (e.g., without state separation) and may be repeatedly re-mixed and/or re-frothed without a decrease in functionality.

### 6.1 Non-Dairy Milk Composition

In one implementation, the base mixture 100 can form a consumable, non-dairy “milk” analog configured to exhibit similar taste, texture, nutritional value, and/or functionality as a dairy milk. In this implementation, the base mixture 100 can include: a proportion of water 110; a proportion of calcium 130 and/or salts 120 (e.g., CLG, TCP, DKP); a proportion of plant-extracted proteins 140 (e.g., chickpea proteins, pea proteins, rice proteins, canola proteins, potato proteins, fava bean proteins); a proportion of starches (e.g., maltodextrin); a proportion of sweeteners 160 (e.g., sugar); a proportion of protein stabilizing agents (e.g., pectin); a proportion of fat 170 (e.g., canola oil); and a proportion of enzymes (e.g., transglutaminase). Additionally, the base mixture 100 can selectively include a proportion of a pH adjustor configured to regulate pH of the base mixture 100 within a target pH range, such as corresponding to a target functionality of the resulting non-dairy milk.

In particular, in one example, the base mixture 100 can include: a proportion of water 110 defining a concentration between 85 percent and 95 percent; a proportion of plant-extracted proteins 140—including a proportion of albumin proteins (e.g., chickpea proteins) configured to impart a target functionality to the base mixture 100 and a proportion of globulin proteins (e.g., pea proteins, fava bean proteins) configured to stabilize the emulsion forming the base mixture 100-defining a concentration between one percent and five percent by weight; a proportion of enzymes (e.g., transglutaminase) defining a concentration less than one percent by weight; a proportion of starches (e.g., maltodextrin) defining a concentration between 0.1 percent 0.5 percent by weight; a proportion of sweeteners 160 (e.g., sugar) defining a concentration between zero percent and two percent by weight; a proportion of calcium 130 and/or salts 120 (e.g., CLG, TCP, DKP) defining a concentration between 0.1 percent and 1 percent by weight; a proportion of protein stabilizing agents (e.g., pectin, food gums) defining a concentration between zero percent and two percent by weight; and a proportion of fat 170 (e.g., canola oil) defining a concentration between two percent and eight percent by weight.

### 6.2 Example: Non-Dairy Milk Processing

Generally, in this implementation, a set of ingredients—including water 110, salt 120, calcium 130, starches, plant-extracted proteins 140, protein stabilizers, sweeteners 160, and fat 170—can be mixed in a particular order to form the emulsion. In particular, the proportion of salt 120 and the proportion of calcium 130 can be added to the proportion of water 110 to form a first mixture. Separately, the proportion of stabilizing agents, the proportion of sweeteners 160, the proportion of starches, and/or the proportion of plant-extracted proteins 140—including a proportion of albumin proteins and a proportion of globulin proteins—can be mixed to form a second mixture, which can then be added to the first mixture to form a blend. The proportion of fat 170 (e.g., canola oil) can then be emulsified into the blend to form the emulsion.

For example, the proportion of water 110 can be heated to temperatures between-° F. and—° F. The proportion of salts 120 (e.g., DKP) and/or the proportion of calcium 130 (e.g., TCP) can then be added to the proportion of water 110 in a mixer to form a first mixture. The first mixture can then be mixed for two minutes at high shear (e.g., 30 Hz) for a duration of approximately ten minutes. Separately, the proportion of stabilizing agents (e.g., pectin), the proportion of sweeteners 160, the proportion of starches, and/or the proportion of plant-extracted proteins 140—including the proportion of albumin proteins (e.g., chickpea proteins) and the proportion of globulin proteins (e.g., pea proteins, fava bean proteins)—can be mixed to form a second mixture. The second mixture can then be added to the first mixture to form a blend. The blend can then be mixed at high shear (e.g., 60 Hz) for a duration of approximately ten minutes. The proportion of oil can then be added to the blend and mixed at a high speed (e.g., 60 Hz) for a duration of approximately 5 minutes to form an emulsion.

During an activation period: the emulsion can be heated to an activation temperature (e.g., ° F.) within a temperature range associated with enzymatic activity of transglutaminase enzymes; a proportion of transglutaminase enzymes (e.g., TI transglutaminase, RS transglutaminase, and/or PG transglutaminase) can be added to the emulsion at the activation temperature; and, during a hold period of a fixed duration (e.g., 3 minutes, 5 minutes, 10 minutes), the resulting emulsion—including the proportion of transglutaminase enzymes—can be held at the activation temperature (e.g., within a jacketed, high-shear mixing tank) to promote activation of transglutaminase enzymes, in the proportion of transglutaminase enzymes, and, thereby, formation of protein bonds between amino acid chains of proteins in the proportion of plant-extracted proteins 140. In particular, the emulsion can be held at the activation temperature for the fixed duration associated with a target magnitude (e.g., amount, strength) of protein bonding.

In response to expiration of the fixed duration of the hold period, the emulsion can be rapidly heated to a deactivation temperature (e.g., 180° F., 190° F.) and held at the deactivation temperature—for a particular duration—in order to promote deactivation of “activated” transglutaminase enzymes and, thereby, reduce and/or inhibit formation of protein bonds between amino acid chains of proteins, in the proportion of plant-extracted proteins 140, during a deactivation period.

The emulsion—including the proportion of “deactivated” transglutaminase enzymes—can then be pasteurized, homogenized, and further processed according to the method S100s and techniques described above.

For example, during a pasteurization period succeeding the deactivation period, the emulsion can be: heated to a relatively high, target temperature (e.g., between 260° F. and 300° F.) and held at this target temperature for a relatively short duration (e.g., between two seconds and six seconds) defined by a selected pasteurization process (e.g., HTST, ESL, aseptic processing). In this example, the emulsion can exhibit relatively high stability due to the presence of enzymatically-modified, plant-extracted proteins 140-defining an increased magnitude of protein bonding between amino acid chains of plant-extracted proteins 140 (e.g., albumin proteins) in the proportion of plant-extracted proteins 140—and therefore maintain a target functionality (e.g., characterized by foaming, gelling, and/or solubility) of the base mixture 100 formed of the emulsion. Alternatively, in another example, during the pasteurization period succeeding the deactivation period, the emulsion can be: heated to a relatively low, target temperature (e.g., between ° F. and 165° F.) and held at this target temperature for a relatively long duration (e.g., 25 minutes, 30 minutes, 60 minutes) defined by a selected pasteurization process (e.g., low-temperature-high-duration).

In each of these examples, the emulsion can then be homogenized during a homogenization period succeeding the pasteurization period. For example, during the homogenization period, the emulsion can be homogenized at approximately 40,000 psi—such as including a first stage at approximately 2500 psi and a second stage at approximately 500 psi—to form a first batch of the base mixture. The base mixture 100 can then be cooled to a target temperature and packaged accordingly, such as in a standard container (e.g., a carton) for milk, creamer, or other milk-based products.

The foregoing methods of processing the base mixture may be executed by a twin screw extruder. For example, the twin screw extruder may pressurize, heat, and/or cool the base mixture to form a target non-dairy milk product which may be packaged and stored accordingly.

### 6.3 Functional, Non-Dairy Cheese

In one variation, the non-dairy milk (or emulsion), as described herein, can include additional ingredients and undergo further processing to form a functional, enzymatically enhanced non-dairy cheese product.

In this variation, the base mixture 100 further includes: a sixth portion of an acid; a seventh portion of a coagulating agent 175; an eighth portion of a fat 170 source; and a ninth portion of a salt 120. Furthermore, in this variation, the base mixture 100 includes: the first portion of the starch 150 defining a first concentration between one and five percent by weight; the second portion of the plant-extracted protein 140 defining a second concentration between three and ten percent by weight; the third portion of sugar units 154 defining a third concentration between zero and two percent by weight; the fourth portion of amino acids 144 defining a fourth concentration between zero and one percent by weight; and the eighth portion of the fat 170 source defining a fifth concentration between five and fifteen percent by weight. In this variation, each of these concentrations can be modified based on target characteristics (e.g., functionality, flavor, mouthfeel) for the target non-dairy cheese product.

Furthermore, in this variation, following synthesis of the non-dairy milk, a user may: acidify all or a portion of the non-dairy milk via the sixth portion of acid 174 in Block S180; add coagulate to the acidified non-dairy milk to trigger curd formation; cut the resulting curd; stir, cook, and wash the curd; draw water from the curds; and salt 120 and age the resulting mass, thereby transforming the non-dairy milk into a (hard) cheese at home, such as in a residential kitchen with a microwave or residential stove.

### 6.4 Functional, Non-Dairy Butter

In one variation, the non-dairy milk (or emulsion), as described herein, can include additional ingredients and undergo further processing to form a functional, non-dairy butter product.

In this variation, the base mixture 100 further includes: a sixth portion of water 110; a seventh portion of a hydrocolloid 176; and an eighth portion of an oil. In this implementation, the base mixture 100 includes: the first portion of the starch 150 defining a first concentration between one and three percent by weight; the second portion of the plant-extracted protein 140 defining a second concentration between five and fifteen percent by weight; the fourth portion of amino acids 144 defining a fourth concentration between zero and one percent by weight; and the sixth portion of water 110 defining a fifth concentration between fifty and seventy percent by weight. In this variation, each of these concentrations can be modified based on target characteristics (e.g., functionality, flavor, mouthfeel) for the target non-dairy butter product.

Furthermore, in this variation, a user may: emulsify the non-dairy milk with a portion of water 110 and a first portion of oil; add a portion of a hydrocolloid 176 to stabilize the emulsion; during a thickening period, heat the emulsion (e.g., at 122 degrees Fahrenheit) to promote interactions between the hydrocolloid 176, the starch 150, and the plant-extracted proteins 140; during a cooling period, cool the emulsion (e.g., at 59° F.) to solidify fat 170 content and promote fat 170 crystallization; churn the mixture to achieve a target texture profile; and store the resulting mass, thereby transforming the non-dairy milk into a non-dairy butter at home, such as in a residential kitchen with a microwave or residential stove.

Additionally or alternatively, the non-dairy milk can be enzymatically modified to reduce the need for additional fats 170 to be added to the base mixture 100 to generate a butter product. More specifically, a first amount of protease can: hydrolyze plant-extracted proteins 140 into amino acids 144 in the non-dairy milk to increase solubility of these plant-extracted proteins 140; and hydrolyze plant-extracted proteins 140 into peptides configured to interact with the hydrocolloid 176 to further stabilize the base mixture. Similarly, a second amount of transglutaminase can: synthesize a protein matrix 148 from plant-extracted proteins 140 in the non-dairy milk; and trap water 110 and emulsified oils in the protein matrix 148 to strengthen the emulsion, thereby reducing the need for saturated (strengthening) fats 170.

In this example, a user may: add transglutaminase to the base mixture 100 for a target time duration at a target activation temperature between 104° F. and 140° F.; increase the temperature of the base mixture (e.g., 180° F.) to denature transglutaminase; add the portion of hydrocolloids 176 to the non-dairy milk to achieve a target texture profile; emulsify the non-dairy milk with a second portion of oil less than the first portion of oil; cool the emulsion (e.g., to 59° F.); churn the emulsion to achieve the target texture profile; and store the resulting mass, thereby transforming the non-dairy milk into an enzymatically modified non-dairy butter at home, such as a low-fat 170 butter that mimics the characteristics of full fat 170 butter (e.g., texture, creaminess, mouthfeel).

### 7. Powdered Non-dairy Milk

In one variation, the non-dairy milk (or emulsion) as described herein can include additional ingredients and undergo further processing to form a powdered, non-dairy milk.

For example, the method S100 can include: adding a stabilizer (e.g., maltodextrin, modified starch) and/or a protein-based carrier (e.g., whey protein, pea protein isolate) to coat and seal oil droplets 172 in the emulsified base mixture; microfluidizing the base mixture to reduce droplet size; and drying the base mixture to form a powdered non-dairy milk product. In this example, drying the base mixture can include: spray drying the base mixture at a target temperature; freeze drying the base mixture; drum drying the base mixture; vacuum drying the base mixture; and/or fluidized bed drying the base mixture. In this example, in response to drying the base mixture, the method S100 can further include: adding anti-caking agents (e.g., tricalcium phosphate, tapioca starch) to prevent clumping of the powdered non-dairy milk product and promote reconstitution of a functional non-dairy milk product in presence of water.

In another variation, the non-dairy milk (or emulsion), as described herein, can exclude the portion of oil (and/or fat) and undergo further processing to form a powdered, non-dairy milk. In this variation, the method S100 excludes emulsifying the base mixture to form an emulsion and includes drying the base mixture to form a powdered non-dairy milk product. In this example, drying the base mixture can include: spray drying the base mixture at a target temperature; freeze drying the base mixture;—drum drying the base mixture; vacuum drying the base mixture; and/or fluidized bed drying the base mixture. In this example, in response to drying the base mixture, the method S100 can further include: adding anti-caking agents (e.g., tricalcium phosphate, tapioca starch) to prevent clumping of the powdered non-dairy milk product and promote reconstitution of a functional non-dairy milk product in presence of water. Additionally, in this variation, the protein matrix: defines a target proportion similar to a typical target proportion of fats; and defines the target texture (e.g., creaminess) of the end non-dairy milk product formed from the base mixture. In a similar variation, the non-dairy milk product can define a set of dry (or “pre-powdered”) ingredients including: an amount of plant-extracted proteins 140 (e.g., chickpea protein, fava bean protein, pea proteins); an amount of calcium; an amount of potassium (and/or magnesium); and an amount of sugar.

In the foregoing variations, a user may: purchase a portion of powdered non-dairy milk; and add a portion of water (or other liquid) to the portion of powdered non-dairy milk to reconstitute (or form) a consumable, liquid non-dairy milk product. Accordingly, in the foregoing variations, the base mixture can undergo further processing to form a powdered non-dairy milk product, such as an instant non-dairy milk beverage that may be mixed with an instant coffee powder. Therefore, a user may: mix the powdered non-dairy milk product with the instant coffee powder; and add water (e.g., hot water) to the powdered non-dairy milk product and the instant coffee powder to form an instant coffee beverage defining a target proportion of non-dairy milk to coffee. Additionally or alternatively, a user may: purchase a pre-mixed portion of powdered non-dairy milk and instant coffee; and add water (e.g., hot water) to the powdered non-dairy milk product and the instant coffee powder to form an instant coffee beverage defining a target proportion of non-dairy milk to coffee.

### 8. Conclusion

The systems and method S100s described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and method S100s of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A non-dairy milk product comprising:
a first portion of a starch;
a second portion of a plant-extracted protein;
a third portion of sugar units hydrolyzed from the starch by a first enzyme;
a fourth portion of amino acids hydrolyzed from the plant-extracted protein by a second enzyme; and
a fifth portion of a protein matrix synthesized from the plant-extracted protein by a third enzyme.

2. The non-dairy milk product of claim 1:
wherein the third portion of sugar units is hydrolyzed from the starch by the first enzyme comprising an amylase enzyme;
wherein the fourth portion of amino acids is hydrolyzed from the plant-extracted protein by the second enzyme comprising a protease enzyme; and
wherein the fifth portion of the protein matrix is synthesized from the plant-extracted protein by the third enzyme comprising a transglutaminase enzyme.

3. The non-dairy milk product of claim 1:
wherein the third portion of sugar units is hydrolyzed from the starch by the first enzyme comprising an alpha amylase enzyme;
wherein the fourth portion of amino acids is hydrolyzed from the plant-extracted protein by the second enzyme comprising bromelain; and
wherein the fifth portion of the protein matrix is synthesized from the plant-extracted protein by the third enzyme comprising a microbial transglutaminase enzyme.

4. The non-dairy milk product of claim 1:
wherein the third portion of sugar units is hydrolyzed from the starch by the first enzyme, hydrolyzing glycosidic bonds between starch molecules in a first amount of the starch;
wherein the fourth portion of amino acids is hydrolyzed from the plant-extracted protein by the second enzyme, hydrolyzing peptide bonds between amino acids in a second amount of the plant-extracted protein; and
wherein the fifth portion of the protein matrix is synthesized from the plant-extracted protein by the third enzyme, catalyzing bond formation between plant-extracted proteins in a third amount of the plant-extracted protein.

5. The non-dairy milk product of claim 1:
wherein the third portion of sugar units is hydrolyzed from a first amount of the starch via addition of the first enzyme to a mixture, comprising the first portion of the starch and the first amount of the starch, at a first time;
wherein the fourth portion of amino acids is hydrolyzed from a second amount of the plant-extracted protein via addition of the second enzyme to the mixture further comprising the second portion of the plant-extracted protein and the second amount of the plant-extracted protein, at a second time; and
wherein the fifth portion of the protein matrix is synthesized from a third amount of the plant-extracted protein via addition of the third enzyme to the mixture further comprising the third amount of the plant-extracted protein, at a third time succeeding the first time and the second time.

6. The non-dairy milk product of claim 1:
wherein the third portion of sugar units is hydrolyzed from a first amount of the starch via addition of the first enzyme to a mixture, comprising the first portion of the starch and the first amount of the starch, in presence of water;
wherein the fourth portion of amino acids is hydrolyzed from a second amount of the plant-extracted protein via addition of the second enzyme to the mixture further comprising the second portion of the plant-extracted protein and the second amount of the plant-extracted protein, in presence of water;
wherein the fifth portion of the protein matrix is synthesized from a third amount of the plant-extracted protein via addition of the third enzyme to the mixture further comprising the third amount of the plant-extracted protein, in presence of water; and
wherein the first portion of the starch, the second portion of the plant-extracted protein, the third portion of sugar units, the fourth portion of amino acids, and the fifth portion of the protein matrix are dried to form the non-dairy milk product comprising a non-dairy milk powder.

7. The non-dairy milk product of claim 6, further comprising a sixth portion of a carbohydrate configured to stabilize the non-dairy milk powder.

8. The non-dairy milk product of claim 1:
wherein the third portion of sugar units is hydrolyzed from a first amount of the starch via addition of the first enzyme to a mixture comprising the first portion of the starch and the first amount of the starch, the first portion of the starch greater than the first amount of the starch;
wherein the fourth portion of amino acids is hydrolyzed from a second amount of the plant-extracted protein via addition of the second enzyme to the mixture further comprising the second portion of the plant-extracted protein and the second amount of the plant-extracted protein, the second portion of the plant-extracted protein greater than the second amount of the plant-extracted protein; and
wherein the fifth portion of the protein matrix is synthesized from a third amount of the plant-extracted protein via addition of the third enzyme to the mixture further comprising the third amount of the plant-extracted protein, the third amount of the plant-extracted protein greater than the second amount of the plant-extracted protein.

9. The non-dairy milk product of claim 1, further comprising:
a sixth portion of water; and
a seventh portion of plant-extracted oil droplets:
dispersed throughout the sixth portion of water; and
cooperating with the fifth portion of the protein matrix and the sixth portion of water to form an emulsion.

10. The non-dairy milk product of claim 1:
further comprising:
a sixth portion of an acid;
a seventh portion of a coagulating agent;
an eighth portion of a fat source; and
a ninth portion of a salt;
wherein the first portion of the starch defines a first concentration between one and five percent by weight;
wherein the second portion of the plant-extracted protein defines a second concentration between three and ten percent by weight;
wherein the third portion of sugar units defines a third concentration between zero and two percent by weight;
wherein the fourth portion of amino acids defines a fourth concentration between zero and one percent by weight; and
wherein the eighth portion of the fat source defines a fifth concentration between five and fifteen percent by weight.

11. The non-dairy milk product of claim 1:
further comprising:
a sixth portion of water;
a seventh portion of a hydrocolloid; and
an eighth portion of oil droplets;
wherein the first portion of the starch defines a first concentration between one and three percent by weight;
wherein the second portion of the plant-extracted protein defines a second concentration between five and fifteen percent by weight;
wherein the fourth portion of amino acids defines a fourth concentration between zero and one percent by weight; and
wherein the sixth portion of water defines a fifth concentration between fifty and seventy percent by weight.

12. The non-dairy milk product of claim 1:
wherein the first portion of the starch comprises a first proportion of potato starch; and
wherein the second portion of the plant-extracted protein comprises:
a second proportion of albumin proteins; and
a third proportion of globulin proteins.

13. The non-dairy milk product of claim 1, further comprising:
a sixth portion of a salt;
a seventh portion of calcium; and
an eighth portion of a sweetener.

14. A method comprising:
combining a first portion of a starch and a second portion of a plant-extracted protein to form a first mixture;
adding a first enzyme to the first mixture to hydrolyze a first proportion of the starch into a third portion of sugar units;
adding a second enzyme to the first mixture to hydrolyze a second proportion of the plant-extracted protein into a fourth portion of amino acids to form a second mixture comprising:
the first portion of the starch;
the second portion of the plant-extracted protein;
the third portion of sugar units; and
the fourth portion of amino acids; and
adding a third enzyme to the second mixture to synthesize a fifth portion of a protein matrix from a third proportion fourth the plant-extracted protein to form a base mixture comprising:
the first portion of the starch;
the second portion of the plant-extracted protein;
the third portion of sugar units;
the fourth portion of amino acids; and
the fifth portion of the protein matrix.

15. The method of claim 14, further comprising:
spray-drying a volume of the base mixture to transform the base mixture into a powdered state; and
packaging the volume of the base mixture in the powdered state for storage.

16. The method of claim 14, further comprising, during a blending period:
adding a sixth portion of water to the base mixture; and
blending the base mixture and the sixth portion of water with a seventh portion of plant-extracted oil droplets to form an emulsion.

17. The method of claim 16, further comprising:
during a pasteurization period succeeding the blending period, pasteurizing the emulsion at temperatures within a first temperature range and for a first duration; and
during a homogenization period succeeding the pasteurization period, homogenizing the emulsion at temperatures within a second temperature range and for a second duration.

18. The method of claim 14:
wherein adding the first enzyme to the first mixture comprises adding the first enzyme to the first mixture at a first time;
wherein adding the second enzyme to the first mixture comprises adding the second enzyme to the first mixture at a second time; and
wherein adding the third enzyme to the second mixture comprises adding the third enzyme to the second mixture at a third time succeeding the first time and the second time.

19. The method of claim 14:
wherein adding the first enzyme to the first mixture comprises:
adding the first enzyme to the first mixture;
holding the first mixture at a first temperature for a first time duration, the first temperature falling within a first target enzymatic temperature range corresponding to the first enzyme; and
adjusting the first temperature of the first mixture to a second temperature following the first time duration, the second temperature excluded from the first target enzymatic temperature range;
wherein adding the second enzyme to the first mixture comprises:
adding the second enzyme to the first mixture;
holding the first mixture at a third temperature for a second time duration, the third temperature falling within a second target enzymatic temperature range corresponding to the second enzyme; and
adjusting the third temperature of the first mixture to a fourth temperature following the second time duration, the fourth temperature excluded from the second target enzymatic temperature range; and
wherein adding the third enzyme to the second mixture comprises:
adding the third enzyme to the second mixture;
holding the second mixture at a fifth temperature for a third time duration, the fifth temperature falling within a third target enzymatic temperature range corresponding to the third enzyme; and
adjusting the fifth temperature of the second mixture to a sixth temperature following the third time duration, the sixth temperature excluded from the third target enzymatic temperature range.

20. A non-dairy milk product comprising:
a first portion of a starch;
a second portion of plant-extracted proteins;
a first amount of a first enzyme configured to catalyze hydrolysis of a first proportion of the first portion of the starch into sugar units;
a second amount of a second enzyme configured to catalyze hydrolysis of a second proportion of the second portion of plant-extracted proteins into amino acids; and
a third amount of a third enzyme configured to catalyze synthesis of protein bonds between plant-extracted proteins in a third proportion of the second portion of the plant-extracted proteins to form a protein matrix.
